(19) United States
(12) Patent Application Publication
(10) Pub. No.: US 2018/0173534 A1
(43) Pub. Date: Jun. 21, 2018

(54) Branch Predictor with Branch Resolution Code Injection

(71) Applicant: Intel Corporation, Santa Clara, CA (US)

(72) Inventors: Leeor Peled, Haifa (IL); Gadi Haber, Nesher (IL); Yiannakis Sazeides, Nicosia (CY)

(21) Appl. No.: 15/385,011

(22) Filed: Dec. 20, 2016

(51) Int. Cl. G06F 9/38; G06F 9/30

(52) U.S. Cl. CPC G06F 9/3806; G06F 9/3016

(57) ABSTRACT

A processor may include a decoder to decode a first instance of a branch instruction for which the resolved branch direction is data dependent and add results of the decoding to a stream of decoded instructions for execution. The processor may include a code generator to inject, into the stream of decoded instructions, branch resolution code to resolve the branch condition for a second instance of the branch instruction following the first instance at a predetermined look-ahead distance. The processor may include an execution unit to execute the branch resolution code, storing an indication of the resolved branch direction for the second instance in an entry of a prediction queue for the branch instruction. The processor may include a branch predictor to receive the second instance of the branch instruction, and output the resolved branch direction as the predicted branch direction for the second instance of the branch instruction.

### FIELD OF THE INVENTION

The present disclosure pertains to the field of processing logic, microprocessors, and associated instruction set architecture that, when executed by the processor or other processing logic, perform logical, mathematical, or other functional operations.

### DESCRIPTION OF RELATED ART

Multiprocessor systems are becoming more and more common. In order to take advantage of multiprocessor systems, code to be executed may be separated into multiple threads for execution by various processing entities. Each thread may be executed in parallel with one another. Pipelining of applications may be implemented in systems in order to more efficiently execute applications. Instructions as they are received on a processor may be decoded into terms or instruction words that are native, or more native, for execution on the processor. Each processor may include a cache or multiple caches. Processors may be implemented in a system on chip.

### DESCRIPTION OF THE FIGURES

Various embodiments of the present disclosure are illustrated by way of example and not limitation in the Figures of the accompanying drawings, in which like references indicate similar elements, and in which:

FIG. 1A is a block diagram of an exemplary computer system formed with a processor that may include execution units to execute an instruction, in accordance with embodiments of the present disclosure;

FIG. 1B illustrates a data processing system, in accordance with embodiments of the present disclosure;

FIG. 1C illustrates other embodiments of a data processing system for performing text string comparison operations;

FIG. 2 is a block diagram illustrating a processor core for performing flakey branch prediction, in accordance with some embodiments of the present disclosure;

FIG. 3 is a flow diagram illustrating one embodiment of a method for predicting a branch direction for a flakey branch instruction;

FIG. 4 is a block diagram illustrating selected portions of a processor core that implements flakey branch prediction using branch resolution code injection, in accordance with some embodiments of the present disclosure;

FIG. 5 illustrates a state diagram in which transitions between multiple states of a flakey branch instruction are depicted, in accordance with some embodiments of the present disclosure;

FIGS. 6A-6C are flow diagrams illustrating one embodiment of a method for performing flakey branch prediction;

FIG. 7 is a flow diagram illustrating one embodiment of a method for handling a flakey branch instruction in a processor core front end;

FIG. 8 is a flow diagram illustrating one embodiment of a method for executing decoded instructions, including flakey branch instructions;

FIG. 9A is a block diagram illustrating an in-order pipeline and a register renaming, out-of-order issue/execution pipeline, according to some embodiments of the present disclosure;

FIG. 9B is a block diagram illustrating an in-order architecture core and register renaming, out-of-order issue/execution logic to be included in a processor, according to some embodiments of the present disclosure;

FIGS. 10A and 10B are block diagrams illustrating an example in-order core architecture, according to some embodiments of the present disclosure;

FIG. 11 illustrating a block diagram illustrating a processor, according to some embodiments of the present disclosure;

FIGS. 12 through 15 are block diagrams illustrating example computer architectures, according to some embodiments of the present disclosure; and

FIG. 16 is a block diagram illustrating the use of a compiler and a software instruction converter to convert binary instructions in a source instruction set to binary instructions in a target instruction set, according to some embodiments of the present disclosure.

### DETAILED DESCRIPTION

The following description describes an instruction and processing logic for implementing flakey branch prediction using branch resolution code injection. Such a processing apparatus may include an out-of-order processor. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that other embodiments may be practiced without such specific details. Additionally, some well-known structures, circuits, and the like have not been shown in detail to avoid unnecessarily obscuring the example embodiments of the present disclosure included herein.

References in the specification to “one embodiment,” “an embodiment,” “an example embodiment,” etc., indicate that the embodiment described may include a particular feature, structure, or characteristic. However, not all embodiments of the present disclosure necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to affect such a feature, structure, or characteristic in connection with other embodiments of the disclosure, whether or not such a connection is explicitly described.

Although some example embodiments are described with reference to a processor, other embodiments may be applicable to other types of integrated circuits and logic devices. Similar techniques and teachings of various embodiments of the present disclosure may be applied to other types of circuits or semiconductor devices that may benefit from higher pipeline throughput and improved performance. The teachings of the example embodiments of the present disclosure may be applicable to any processor or machine that performs data manipulations. However, other embodiments are not limited to processors or machines that perform 512-bit, 256-bit, 128-bit, 64-bit, 32-bit, or 16-bit data operations and may be applied to any processor and machine in which manipulation or management of data may be performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the examples below describe instruction handling and distribution in the context of execution units and logic circuits, other embodiments of the present disclosure may be accomplished by way of data or instructions stored on a machine-readable, tangible medium, which when performed by a machine cause the machine to perform functions consistent with at least one embodiment of the disclosure. In some embodiments, functions associated with embodiments of the present disclosure may be embodied in machine-executable instructions. The instructions may be used to cause a general-purpose or special-purpose processor that may be programmed with the instructions to perform the operations of the present disclosure. Some embodiments of the present disclosure may be provided as a computer program product or software which may include a machine or computer-readable medium having stored thereon instructions which may be used to program a computer (or other electronic devices) to perform one or more operations according to embodiments of the present disclosure. Furthermore, operations of some embodiments of the present disclosure might be performed by specific hardware components that contain fixed-function logic for performing the operations, or by any combination of programmed computer components and fixed-function hardware components. Throughout this disclosure, unless explicitly stated otherwise, a compound form of a reference numeral refers to the element generically or collectively. Thus, for example, widget 101A or 101-1 refers to an instance of a widget class, which may be referred to collectively as widgets 101 and any one of which may be referred to generically as widget 101.

Instructions used to program logic to perform some embodiments of the present disclosure may be stored within a memory in the system, such as DRAM, cache, flash memory, or other storage. Furthermore, the instructions may be distributed via a network or by way of other computer-readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium may include any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as may be useful in simulations, the hardware may be represented using a hardware description language or another functional description language. Additionally, a circuit level model with logic and/or transistor gates may be produced at some stages of the design process. Furthermore, designs, at some stage, may reach a level of data representing the physical placement of various devices in the hardware model. In cases wherein some semiconductor fabrication techniques are used, the data representing the hardware model may be the data specifying the presence or absence of various features on different mask layers for masks used to produce the integrated circuit. In any representation of the design, the data may be stored in any form of a machine-readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or retransmission of the electrical signal is performed, a new copy may be made. Thus, a communication provider or a network provider may store on a tangible, machine-readable medium, at least temporarily, an article, such as information encoded into a carrier wave, embodying techniques of embodiments of the present disclosure.

In modern processors, a number of different execution units may be used to process and execute a variety of code and instructions. Some instructions may be quicker to complete while others may take a number of clock cycles to complete. The faster the throughput of instructions, the better the overall performance of the processor. Thus it would be advantageous to have as many instructions execute as fast as possible. However, there may be certain instructions that have greater complexity and require more in terms of execution time and processor resources, such as floating point instructions, load/store operations, data moves, etc.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which may include processor logic and circuits used to implement one or more instruction sets. Accordingly, processors with different micro-architectures may share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion of a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT), a Reorder Buffer (ROB) and a retirement register file. In one embodiment, registers may include one or more registers, register architectures, register files, or other register sets that may or may not be addressable by a software programmer.

An instruction may include one or more instruction formats. In one embodiment, an instruction format may indicate various fields (number of bits, location of bits, etc.) to specify, among other things, the operation to be performed and the operands on which that operation will be performed. In a further embodiment, some instruction formats may be further defined by instruction templates (or sub-formats). For example, the instruction templates of a given instruction format may be defined to have different subsets of the instruction format's fields and/or defined to have a given field interpreted differently. In one embodiment, an instruction may be expressed using an instruction format (and, if defined, in a given one of the instruction templates of that instruction format) and specifies or indicates the operation and the operands upon which the operation will operate.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that may logically divide the bits in a register into a number of fixed-sized or variable-sized data elements, each of which represents a separate value. For example, in one embodiment, the bits in a 64-bit register may be organized as a source operand containing four separate 16-bit data elements, each of which represents a separate 16-bit value. This type of data may be referred to as ‘packed’ data type or ‘vector’ data type, and operands of this data type may be referred to as packed data operands or vector operands. In one embodiment, a packed data item or vector may be a sequence of packed data elements stored within a single register, and a packed data operand or a vector operand may a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

In one embodiment, destination and source registers/data may be generic terms to represent the source and destination of the corresponding data or operation. In some embodiments, they may be implemented by registers, memory, or other storage areas having other names or functions than those depicted. For example, in one embodiment, “DEST1” may be a temporary storage register or other storage area, whereas “SRC1” and “SRC2” may be a first and second source storage register or other storage area, and so forth. In other embodiments, two or more of the SRC and DEST storage areas may correspond to different data storage elements within the same storage area (e.g., a SIMD register). In one embodiment, one of the source registers may also act as a destination register by, for example, writing back the result of an operation performed on the first and second source data to one of the two source registers serving as a destination registers.

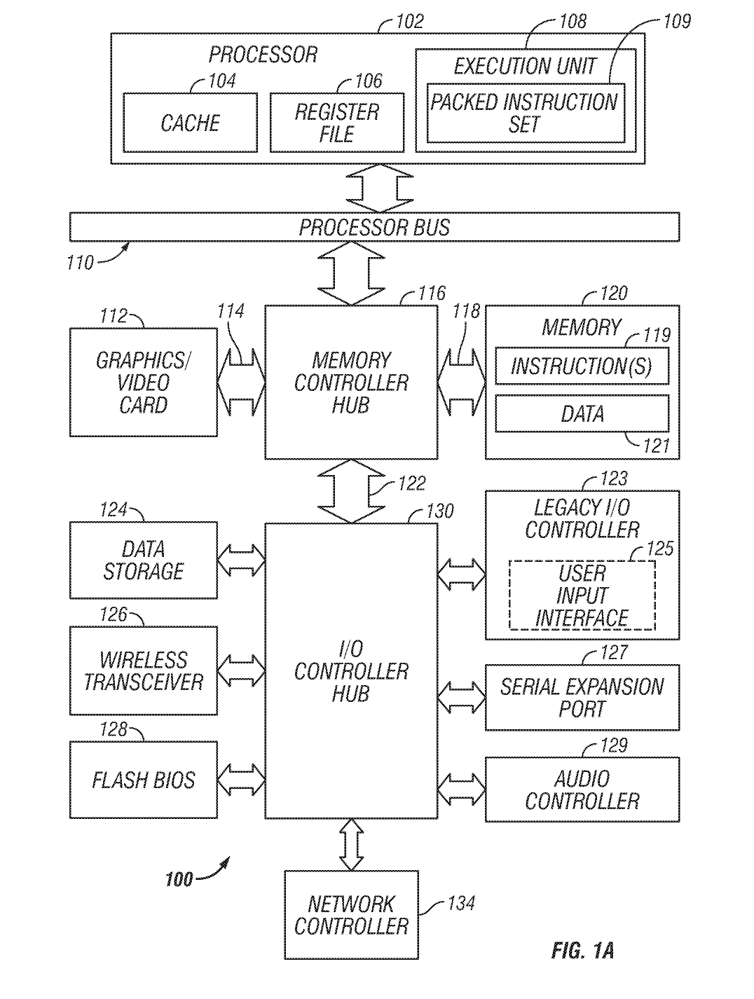

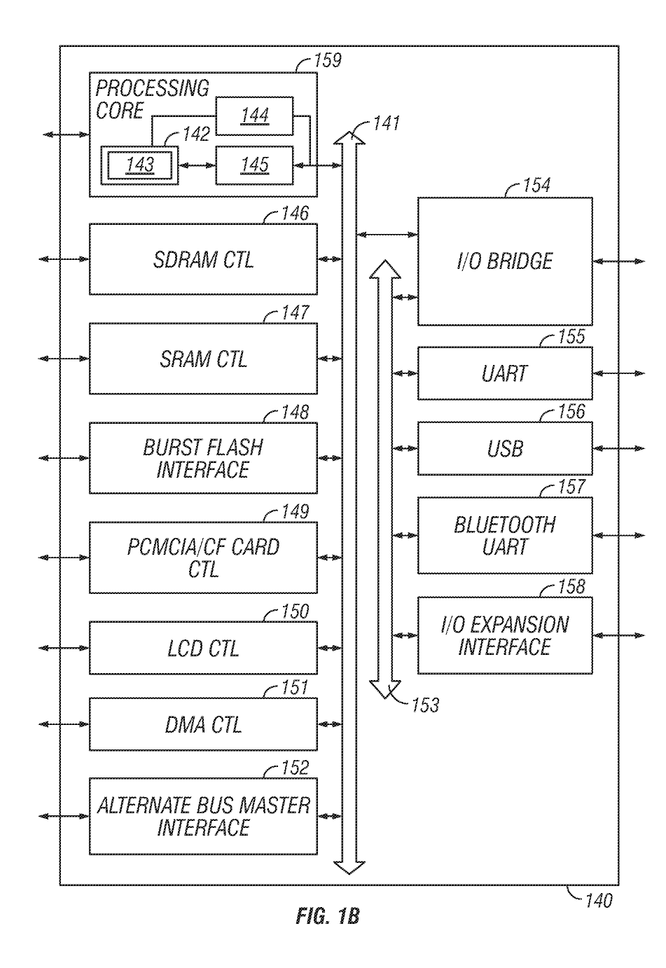

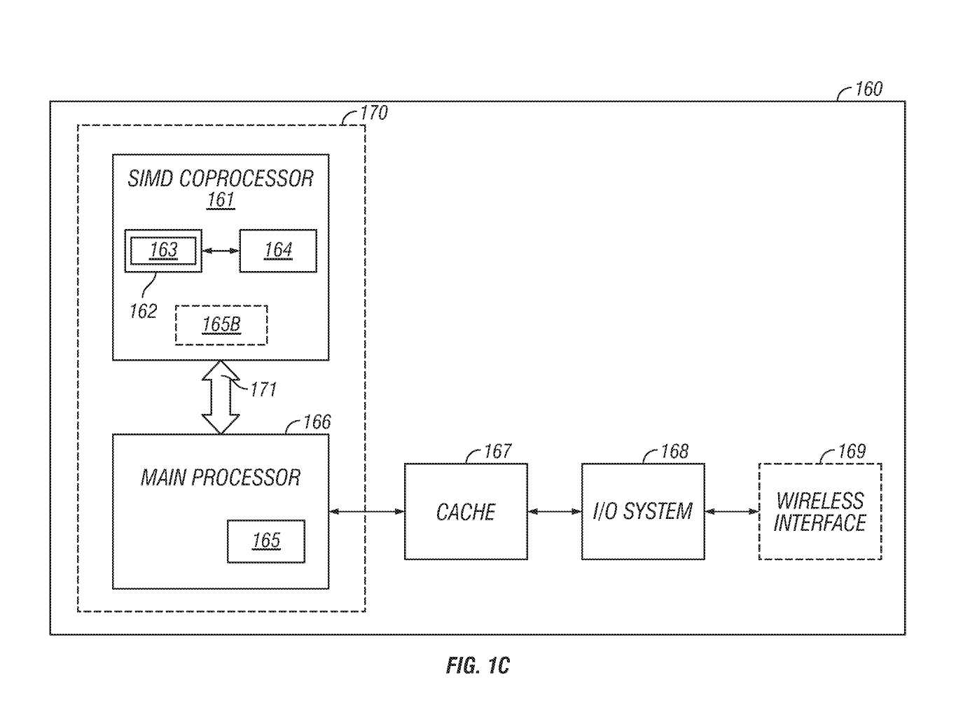

FIG. 1A is a block diagram of an exemplary computer system formed with a processor that may include execution units to execute an instruction, in accordance with some embodiments of the present disclosure. System 100 may include a component, such as a processor 102, to employ execution units including logic to perform algorithms for processing data, in accordance with the present disclosure, such as in the example embodiments described herein. System 100 may be representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments of the present disclosure are not limited to computer systems. Some embodiments of the present disclosure may be used in other devices such as handheld devices and embedded applications. Some examples of handheld devices include cellular phones, Internet Protocol devices, digital cameras, personal digital assistants (PDAs), and handheld PCs. Embedded applications may include a micro controller, a digital signal processor (DSP), system on a chip, network computers (NetPC), set-top boxes, network hubs, wide area network (WAN) switches, or any other system that may perform one or more instructions in accordance with at least one embodiment.

Computer system 100 may include a processor 102 that may include one or more execution units 108 to perform an algorithm to perform at least one instruction in accordance with one embodiment of the present disclosure. One embodiment may be described in the context of a single processor desktop or server system, but other embodiments may be included in a multiprocessor system. System 100 may be an example of a ‘hub’ system architecture. System 100 may include a processor 102 for processing data signals. Processor 102 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In one embodiment, processor 102 may be coupled to a processor bus 110 that may transmit data signals between processor 102 and other components in system 100. The elements of system 100 may perform conventional functions that are well known to those familiar with the art.

In one embodiment, processor 102 may include a Level 1 (L1) internal cache memory 104. Depending on the architecture, the processor 102 may have a single internal cache or multiple levels of internal cache. In another embodiment, the cache memory may reside external to processor 102. Other embodiments may also include a combination of both internal and external caches depending on the particular implementation and needs. Register file 106 may store different types of data in various registers including integer registers, floating point registers, status registers, and instruction pointer register.

Execution unit 108, including logic to perform integer and floating point operations, also resides in processor 102. Processor 102 may also include a microcode (ucode) ROM that stores microcode for certain macroinstructions. In one embodiment, execution unit 108 may include logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications may be accelerated and executed more efficiently by using the full width of a processor's data bus for performing operations on packed data. This may eliminate the need to transfer smaller units of data across the processor's data bus to perform one or more operations one data element at a time.

Some embodiments of an execution unit 108 may also be used in micro controllers, embedded processors, graphics devices, DSPs, and other types of logic circuits. System 100 may include a memory 120. Memory 120 may be implemented as a dynamic random access memory (DRAM) device, a static random access memory (SRAM) device, flash memory device, or other memory device. Memory 120 may store instructions 119 and/or data 121 represented by data signals that may be executed by processor 102.

A system logic chip 116 may be coupled to processor bus 110 and memory 120. System logic chip 116 may include a memory controller hub (MCH). Processor 102 may communicate with MCH 116 via a processor bus 110. MCH 116 may provide a high bandwidth memory path 118 to memory 120 for storage of instructions 119 and data 121 and for storage of graphics commands, data and textures. MCH 116 may direct data signals between processor 102, memory 120, and other components in system 100 and to bridge the data signals between processor bus 110, memory 120, and system I/O 122. In some embodiments, the system logic chip 116 may provide a graphics port for coupling to a graphics controller 112. MCH 116 may be coupled to memory 120 through a memory interface 118. Graphics card 112 may be coupled to MCH 116 through an Accelerated Graphics Port (AGP) interconnect 114.

System 100 may use a proprietary hub interface bus 122 to couple MCH 116 to I/O controller hub (ICH) 130. In one embodiment, ICH 130 may provide direct connections to some I/O devices via a local I/O bus. The local I/O bus may include a high-speed I/O bus for connecting peripherals to memory 120, chipset, and processor 102. Examples may include the audio controller 129, firmware hub (flash BIOS) 128, wireless transceiver 126, data storage 124, legacy I/O controller 123 containing user input interface 125 (which may include a keyboard interface), a serial expansion port 127 such as Universal Serial Bus (USB), and a network controller 134. Data storage device 124 may comprise a hard disk drive, a floppy disk drive, a CD-ROM device, a flash memory device, or other mass storage device.

In another example system, an instruction in accordance with one embodiment may be used with a system on a chip. One embodiment of a system on a chip comprises of a processor and a memory. The memory for one such system may include a flash memory. The flash memory may be located on the same die as the processor and other system components. Additionally, other logic blocks such as a memory controller or graphics controller may also be located on a system on a chip.

FIG. 1B illustrates a data processing system 140 which implements the principles of embodiments of the present disclosure. It will be readily appreciated by one of skill in the art that the embodiments described herein may operate with alternative processing systems without departure from the scope of embodiments of the disclosure.

Computer system 140 comprises a processing core 159 for performing at least one instruction in accordance with one embodiment. In one embodiment, processing core 159 represents a processing unit of any type of architecture, including but not limited to a CISC, a RISC or a VLIW type architecture. Processing core 159 may also be suitable for manufacture in one or more process technologies and by being represented on a machine-readable media in sufficient detail, may be suitable to facilitate said manufacture.

Processing core 159 comprises an execution unit 142, a set of register files 145, and a decoder 144. Processing core 159 may also include additional circuitry (not shown) which may be unnecessary to the understanding of embodiments of the present disclosure. Execution unit 142 may execute instructions received by processing core 159. In addition to performing typical processor instructions, execution unit 142 may perform instructions in packed instruction set 143 for performing operations on packed data formats. Packed instruction set 143 may include instructions for performing embodiments of the disclosure and other packed instructions. Execution unit 142 may be coupled to register file 145 by an internal bus. Register file 145 may represent a storage area on processing core 159 for storing information, including data. As previously mentioned, it is understood that the storage area may store the packed data might not be critical. Execution unit 142 may be coupled to decoder 144. Decoder 144 may decode instructions received by processing core 159 into control signals and/or microcode entry points. In response to these control signals and/or microcode entry points, execution unit 142 performs the appropriate operations. In one embodiment, the decoder may interpret the opcode of the instruction, which will indicate what operation should be performed on the corresponding data indicated within the instruction.

Processing core 159 may be coupled with bus 141 for communicating with various other system devices, which may include but are not limited to, for example, synchronous dynamic random access memory (SDRAM) control 146, static random access memory (SRAM) control 147, burst flash memory interface 148, personal computer memory card international association (PCMCIA)/compact flash (CF) card control 149, liquid crystal display (LCD) control 150, direct memory access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, universal asynchronous receiver/transmitter (UART) 155, universal serial bus (USB) 156, Bluetooth wireless UART 157 and I/O expansion interface 158.

One embodiment of data processing system 140 provides for mobile, network and/or wireless communications and a processing core 159 that may perform SIMD operations including a text string comparison operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates other embodiments of a data processing system that performs SIMD text string comparison operations. In one embodiment, data processing system 160 may include a main processor 166, a SIMD coprocessor 161, a cache memory 167, and an input/output system 168. Input/output system 168 may optionally be coupled to a wireless interface 169. SIMD coprocessor 161 may perform operations including instructions in accordance with one embodiment. In one embodiment, processing core 170 may be suitable for manufacture in one or more process technologies and by being represented on a machine-readable media in sufficient detail, may be suitable to facilitate the manufacture of all or part of data processing system 160 including processing core 170.

In one embodiment, SIMD coprocessor 161 comprises an execution unit 162 and a set of register files 164. One embodiment of main processor 166 comprises a decoder 165 to recognize instructions of instruction set 163 including instructions in accordance with one embodiment for execution by execution unit 162. In other embodiments, SIMD coprocessor 161 also comprises at least part of decoder 165 (shown as 165B) to decode instructions of instruction set 163. Processing core 170 may also include additional circuitry (not shown) which may be unnecessary to the understanding of embodiments of the present disclosure.

In operation, main processor 166 executes a stream of data processing instructions that control data processing operations of a general type including interactions with cache memory 167, and input/output system 168. Embedded within the stream of data processing instructions may be SIMD coprocessor instructions. Decoder 165 of main processor 166 recognizes these SIMD coprocessor instructions as being of a type that should be executed by an attached SIMD coprocessor 161. Accordingly, main processor 166 issues these SIMD coprocessor instructions (or control signals representing SIMD coprocessor instructions) on the coprocessor bus 171. From coprocessor bus 171, these instructions may be received by any attached SIMD coprocessors. In this case, SIMD coprocessor 161 may accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. In one embodiment of processing core 170, main processor 166, and a SIMD coprocessor 161 may be integrated into a single processing core 170 comprising an execution unit 162, a set of register files 164, and a decoder 165 to recognize instructions of instruction set 163 including instructions in accordance with one embodiment.

As the width and depth of out-of-order pipelines increase, the use of improved branch prediction mechanisms that reduce the number of mispredicted instructions in the pipeline may be increasingly beneficial. This may be especially true in the case of branch prediction mechanisms that reduce the number of mispredicted instructions that enter the pipeline as a result of the misprediction of the direction of conditional branches, as such branches are typically the dominant class among all branch instructions.

Some branch predictors employed within existing processors associate a global history of a branch instruction (which may include a history of the path taken by a series of branches through the currently executing program code to reach the branch instruction) with an address identifier of the branch instruction (such as an instruction pointer value or program counter value associated with the branch instruction). These global-history-based branch predictors typically capture branch direction information, which indicates how often the resolved direction of the branch instruction is taken or not taken, to provide predictions for future instances of the branch instruction.

Some existing branch predictors employ elaborate pattern detection mechanisms, but these often fall short when the branch direction for a given branch instruction is data dependent and does not exhibit recurring patterns. In at least some embodiments of the present disclosure, a mechanism for analyzing these “flakey” branch instructions may identify such branches, and may inject synchronized assist flows into the executing code stream at runtime. These assist flows, which are sometimes referred to herein as branch resolution code slices, may compute the branch direction for future iterations of a given branch instruction depend in advance, by resolving the data-dependent conditions on which they depend, and may record the resolved branch direction in the branch predictor, thus allowing better prediction and increased performance.

In at least some embodiments of the present disclosure, a branch predictor may include a baseline branch predictor, such as the global-history-based branch predictors described above, and may also include a mechanism to override the decision of that baseline predictor, under certain circumstances, based on a predicted branch direction that was resolved in advance for a flakey branch instruction. For example, the branch predictor may include hardware circuitry to perform flakey branch code analysis, to construct branch resolution code slices, to inject branch resolution code slices into the executing code stream, and to record the resulting resolved branch directions for one or more future iterations of the flakey branch instruction. The branch predictor may also include hardware circuitry to override an initial branch prediction made by a baseline branch predictor based on the recorded branch direction information that was generated by the injected branch resolution code slices. In at least some embodiments, by overriding an initial prediction of the branch direction generated by a baseline branch predictor in favor of a branch direction that was resolved in advance using the mechanisms described herein, the number of mispredictions may be reduced.

As described in more detail herein, a branch predictor that implements flakey branch prediction may provide a queue-based synchronization mechanism based on an iteration count for recurring flakey branches, and on a tagging scheme for branch instruction instances that annotates them throughout their lifetime with the loop count they observed upon their first appearance. This annotation may allow branch resolution code that resolves the branch direction for a future instance of the branch instruction at an arbitrary look-ahead distance (such as in a future iteration) to be injected into the executing code stream, and to drive the outcome of that branch resolution for the future branch instruction instance back into a queue at the head of the processor core pipeline. These results may be consumed once the branch predictor reaches the iteration for which the branch direction was resolved in advance, overriding the normal prediction process by replacing the prediction made by a baseline predictor in favor of a better informed prediction of the branch direction that is based on the actual data that will be used to execute that branch instruction instance.

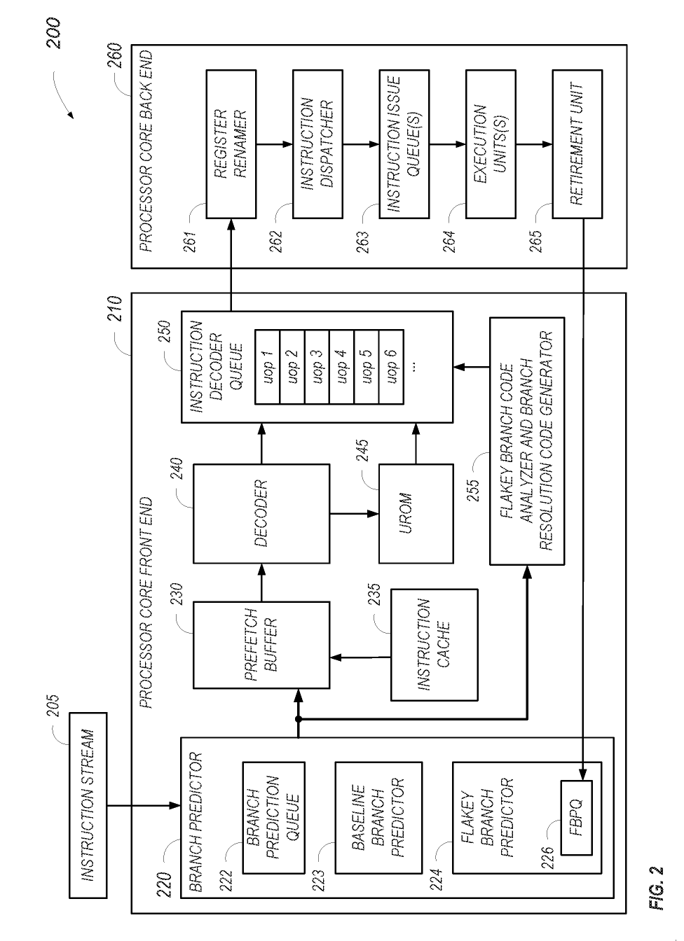

FIG. 2 is a block diagram illustrating a processor core 200 for performing flakey branch prediction, in accordance with some embodiments of the present disclosure. Although processor core 200 is shown and described as an example in FIG. 2, any suitable mechanism may be used. For example, some or all of the functionality of processor core 200 described herein may be implemented by a digital signal processor (DSP), circuitry, instructions for reconfiguring circuitry, a microcontroller, an application specific integrated circuit (ASIC), or a microprocessor having more, fewer, or different elements than those illustrated in FIG. 2. Processor core 200 may include any suitable mechanisms for performing branch prediction flakey branch prediction. In at least some embodiments, such mechanisms may be implemented in hardware. For example, in some embodiments, some or all of the elements of processor core 200 illustrated in FIG. 2 and/or described herein may be implemented fully or in part using hardware circuitry. In some embodiments, this circuitry may include static (fixed-function) logic devices that collectively implement some or all of the functionality of processor core 200. In other embodiments, this circuitry may include programmable logic devices, such as field programmable logic gates or arrays thereof, that collectively implement some or all of the functionality of processor core 200. In still other embodiments, this circuitry may include static, dynamic, and/or programmable memory devices that, when operating in conjunction with other hardware elements, implement some or all of the functionality of processor core 200. For example, processor core 200 may include a hardware memory having stored therein instructions which may be used to program processor core 200 to perform one or more operations according to some embodiments of the present disclosure. Embodiments of processor core 200 are not limited to any specific combination of hardware circuitry and software. Processor core 200 may be implemented fully or in part by the elements described in FIGS. 1A-1C or FIGS. 9-16.

In one embodiment, processor core 200 may receive instructions for execution as an instruction stream 205. In one embodiment, processor core 200 may include a front end 210 to fetch and decode the instructions and a back end 260 to receive and execute the decoded instructions. Front end 210 may include a branch predictor 220, which may include a baseline branch predictor 223 and a flakey branch predictor 224. In some embodiments, flakey branch predictor 224 may include a flakey branch prediction queue (FBPQ) 226. In some embodiments, branch predictor 220 may include a branch prediction queue 222. Data elements stored in each entry of predication queue 222 may represent instruction pointer values or program counter values that identify, or are otherwise associated with, a respective branch instruction. For example, they may include instruction pointer values indicating instructions at which a branch was taken. In one embodiment, branch prediction queue 222 may include storage for up to eight entries. In other embodiments, branch prediction queue 222 may store another number of entries. Branch predictor 220 may also include other elements required to perform branch prediction, such as hardware circuitry to implement baseline branch predictor 223 and flakey branch predictor 224, one or more other buffers or queues (including a branch target buffer), other hardware circuitry, or other static (fixed-function), dynamic, or programmable logic devices (not shown).

As illustrated FIG. 2, in some embodiments, front end 210 may include a prefetch buffer 230 to store data elements representing undecoded instructions to be decoded by decoder 240. Front end 210 may also include an instruction cache 235. In one embodiment, instruction cache 235 may include storage for up to 32K bytes of data representing undecoded instructions. In other embodiments, instruction cache 235 may include storage for more or fewer entries. In some embodiments, instruction-related data elements representing undecoded instructions may be provided to the prefetch buffer 230 for subsequent decoding by decoder 240 from instruction cache 235.

In some embodiments, data elements including branch-related information about undecoded instructions to be decoded by front end 210 may be provided to prefetch buffer 230 from branch prediction queue 222 for use in subsequent decoding operations to be performed by decoder 240. In one embodiment, branch predictor 220 may include hardware circuitry to determine the data elements to be included in branch prediction queue 222. In one embodiment, this information may be used to determine which data elements in instruction cache 235 are to be directed to prefetch buffer 230.

In some embodiments, front end 210 may include a microcode ROM (shown as uROM 245) that stores data elements representing micro-operations (uops) for performing various ones of the instructions received in the input instruction stream 205. In some embodiments, decoder 240 may include hardware circuitry to decode multiple ones of the data elements in prefetch buffer 230 in parallel. In some cases, the decoding operation may include generating one or more uops for each decoded data element. In other cases, the decoding operation may include obtaining one or more uops for each decoded data element from uROM 245, e.g., if a result of a previous decoding operation for the same instruction is available in uROM 245.

In some embodiments, front end 210 may include an instruction decoder queue 250 into which the outputs of decoder 240 are directed. In this example, instruction decoder queue 250 stores decoded instructions in the form of micro-operations (uops). In some embodiments, the decoding of each of the data elements of prefetch buffer 230 by decoder 240 may generate a single uop in queue 250. In other embodiments, for at least some of the data elements that are directed to decoder 240, the decoding may generate two or more uops in instruction decoder queue 250. As illustrated this example, as a result of a decoding operation, uops may be directed to instruction decoder queue 250 from decoder 240 itself, or from uROM 245, depending on whether or not a result of a previous decoding operation for the same instruction is available in uROM 245.

In some embodiments, the outputs of decoder 240 may be provided to instruction decoder queue 250 as an ordered sequence of decoded instructions. The order of the decoded instructions in the sequence of decoded instructions may reflect the program order of the corresponding undecoded instructions that were directed to the decoder 240 through prefetch buffer 230. Subsequently, the in-order sequence of decoded instructions may be provided to an allocation and register renaming stage (shown as register renamer 261) of a processor core back end 260. In some embodiments, register renamer 261 may include a reorder buffer. In some embodiments, processor core back end 260 may also include an instruction dispatcher 262 to schedule and/or dispatch various ones of the decoded instructions to respective instruction issue queues 263. Each of the instruction issue queues may provide decoded instructions to a respective execution unit 264 to execute the decoded instructions. Processor core back end 260 may also include a retirement unit 265, which may implement a write-back to memory of the results of executing the decoded instructions.

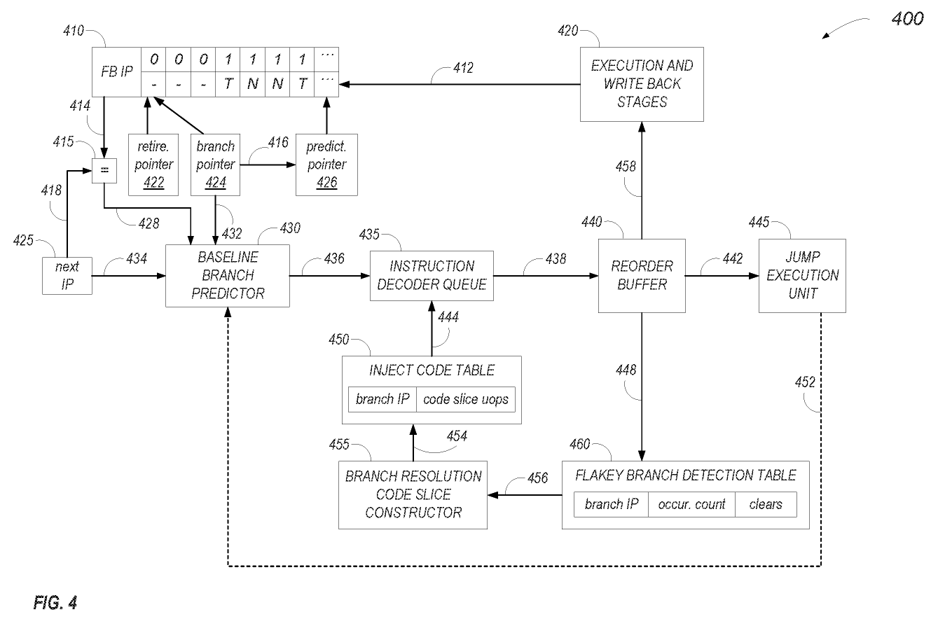

In some embodiments, processor core front end may include a flakey branch code analyzer and branch resolution code generator 255. As described in more detail below, flakey branch code analyzer and branch resolution code generator 255 may include hardware circuitry to detect or identify a flakey branch instruction, to construct a branch resolution code slice that is executable by processor core 200 to resolve the conditions on which the branch direction for one or more future instances of a flakey branch instruction are dependent, and to inject that branch resolution code slice into the stream of decoded instructions to be executed by processor core back end 260. In some embodiments, the branch resolution code slice may be provided to the processor core back end 260, through instruction decoder queue 250, as executable uops. In some embodiments, flakey branch code analyzer and branch resolution code generator 255 may include a branch resolution code slice constructor (such as branch resolution code slice constructor 455 illustrated in FIG. 4) to construct branch resolution code slices, a table for storing code to be injected into the instruction stream (such as inject code table 450 illustrated in FIG. 4), and/or a flakey branch detection table (such as flakey branch detection table 460 illustrated in FIG. 4), example embodiments of which are described below. In at least some embodiments, the branch resolution code slice that is injected into the stream of decoded instructions may include an FBPQ push operation to write the branch direction determined through the resolution of the conditions on which the branch direction for a flakey branch instruction instance is dependent to the FBPQ 266. For example, in at least some embodiments, following the execution of an FBPQ push operation within the branch resolution code slice for a particular flakey branch instruction instance, retirement unit 265 may write data indicating the determined branch direction for the particular flakey branch instruction instance into the FBPQ 226 long before the particular flakey branch instruction is presented for execution.

In at least some embodiments, baseline branch predictor 223 may determine a respective initial prediction of the branch direction for branch instructions in the input instruction stream 205, and may store information indicative of these initial predictions within branch prediction queue 222 in association with respective address identifiers for the branch instruction (such as instruction pointer values or program counter values). In some embodiments, baseline branch predictor 223 may determine the initial predictions based, at least in part, on a global branch history. In some embodiments, flakey branch predictor 224 may determine, based on a previous execution of branch resolution code for a particular flakey branch instruction instance that was injected into the stream of decoded instructions, that an initial prediction of the branch direction for a particular branch instruction instance should be overridden by a prediction of the branch direction for the particular branch instruction instance that is stored in flakey branch prediction queue 226. For example, if a valid prediction for the particular branch instruction instance is stored in flakey branch prediction queue 226, it may be provided as the final prediction for the particular branch instruction instance by branch predictor 220.

As noted above and described in more detail below, the branch prediction techniques described herein may target a subset of the branch instructions in an instruction stream that are frequently mispredicted, and that are data dependent. For example, these branch instructions, which are referred to herein as “flakey” branch instructions, may specify conditions for resolving their branch directions that are dependent on data coming from memory or from computations in which the data values are impossible to predict without knowing where to look for them. In other words, the data values on which the branch resolution conditions depend do not conform to any recognizable or predictable pattern. In some cases, however, while the data values themselves may be unknown, they may reside (e.g., in memory) in locations for which the addresses conform to a pattern that may be easily predicted. For example, an instruction stream may include a sequence of instructions (which may represent multiple iterations of a loop construct controlled by a conditional branch instruction) for traversing a plurality of elements an array in a predictable order, and making branch direction decisions based on the values of those elements. In this example, although the values of the array elements might be completely random, they may be allocated and accessed in the array in a predictable fashion. In some embodiments, the branch predictors described herein may exploit this predictability by looking ahead into future iterations, determining where the data on which the branch condition is dependent is likely to be, pre-emptively obtaining this data, resolving the branch direction (which may include performing one or more computation and/or comparison operations involving the obtained data), and recording the results early enough that they will available for use when the branch instructions for the future iterations arrive at the branch predictor (e.g., some number of iterations ahead of the iterations in which the branch resolutions for these iterations were performed).

The benefits that are achievable by the application of this approach, such as a reduction in the number of mispredicted instructions that enter the processor core pipeline for execution, may be dependent on an assumption that the data on which the branch conditions are dependent has been prepared in the memory in advance. For example, if the instructions within a loop traverse an array, it may be assumed that the data values on which the branch conditions are dependent have been loaded into the array ahead of time, i.e., prior to the instructions iterating over the array to obtain and/or manipulate the data. These techniques may be suitable for application in situations in which the data values on which the branch conditions are dependent are not stored in an array, but are otherwise stored and accessed in a memory in a manner in which the location of the data values needed to resolve branch directions for future iterations is predictable.

In some embodiments, the mechanisms described herein may include hardware circuitry to associate the correct one of the pre-determined resolved branch directions with each of the future iterations for which such pre-determinations are made. For example, the pre-determinations may be made at retirement of a flakey branch instruction instance by hardware circuitry in the back end of the processor core pipeline. However, the results of the pre-determinations may be consumed by hardware circuitry in the front end of the processor core pipeline at some time in the future. Therefore, the branch predictors described herein may include hardware circuitry to implement the synchronization of these two mechanisms. In some embodiments, the injection of branch resolution code may be performed asynchronously. In fact, in some embodiments, it may be performed in an out-of-order fashion, such that the branch direction for an iteration N+1 is determined before the branch direction for iteration N is determined.

In at least some embodiments, the branch predictors described herein may employ a queue-based synchronization mechanism. For example, the queue-based synchronization mechanism may include, for each branch instruction, a counter to count the branch instruction instances (each of which may correspond to a respective loop iteration) in the front end of the processor core, and tagging mechanism to annotate each branch instruction instance that passes the front end with the corresponding value of its instance/iteration counter. In some embodiments, the queue-based synchronization mechanism may include, for each branch instruction, multiple pointers into an entry within a flakey branch prediction queue for that branch instruction. These pointers may identify a current branch instruction instance to be presented to the processor core back end for execution and a future branch instruction instance for which the branch direction is to be resolved by branch resolution code that is injected into the code stream in proximity to the microinstructions (uops) for the current branch instruction instance.

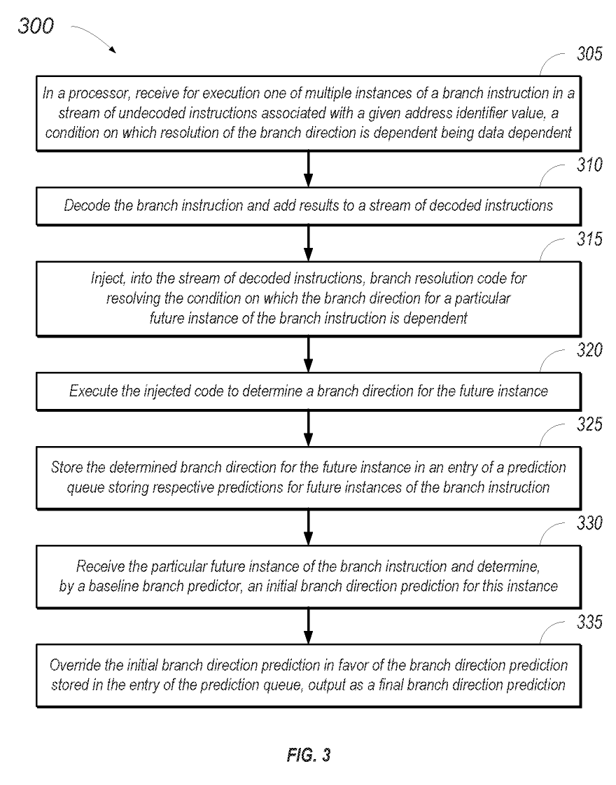

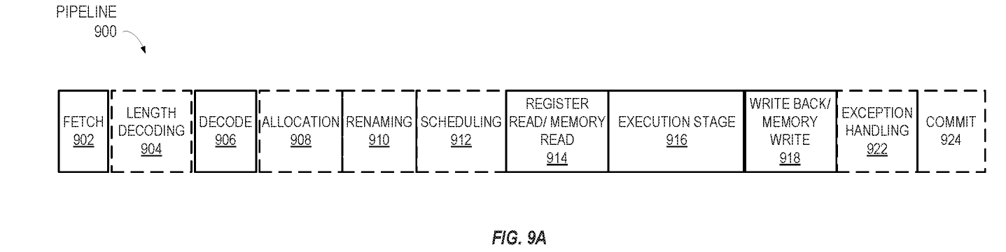

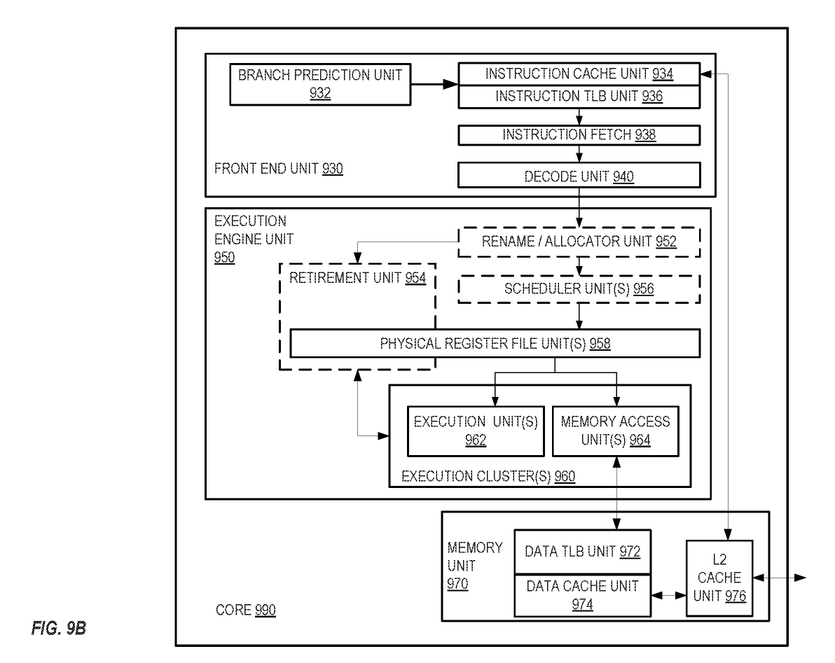

FIG. 3 is a flow diagram illustrating a method 300 for predicting a branch direction for a flakey branch instruction, in accordance with some embodiments of the present disclosure. Method 300 may be implemented by any of the elements shown in FIGS. 1-2, or in FIGS. 9-16. In some embodiments, method 300 may be implemented by hardware circuitry, which may include any suitable combination of static (fixed-function), dynamic, and/or programmable logic devices. In other embodiments, one or more of the operations of method 300 may be performed or emulated by the execution of program instructions. Method 300 may be initiated by any suitable criteria and may initiate operation at any suitable point. In one embodiment, method 300 may initiate operation at 305. Method 300 may include greater or fewer operations than those illustrated. Moreover, method 300 may execute its operations in an order different than those illustrated in FIG. 3. Method 300 may terminate at any suitable operation. Moreover, method 300 may repeat operation at any suitable operation. Method 300 may perform any of its operations in parallel with other operations of method 300, or in parallel with operations of other methods. Furthermore, method 300 may be executed multiple times to perform flakey branch prediction for different flakey branch instructions and different flakey branch instruction instances. During the execution of method 300, other methods may be invoked, such as method 600, method 700, and/or method 800, described below. These additional methods may be invoked to perform at least some of the operations of method 300.

At 305, in one embodiment, one of multiple instances of a branch instruction in a stream of undecoded instructions associated with a given address identifier value may be received, in a processor, for execution. In at least some embodiments, the resolution of a condition on which the branch direction for the branch instruction is dependent may itself be data dependent. For example, the condition may represent a mathematical or logical manipulation of data that is not known, and cannot be predicted, prior to runtime, or may represent a mathematical or logical combination of data that is not known, and cannot be predicted, prior to runtime.

At 310, the branch instruction may be decoded and the results of the decoding operation may be added to a stream of decoded instructions to be presented to an execution engine of the processor for execution. For example, the branch instruction may be decoded into one or more microinstructions (uops) and added to a stream of uops that will subsequently be placed in a queue of decoded instructions to be provided to the execution engine. At 315, branch resolution code for resolving the condition on which the branch direction for a particular future instance of the branch instruction is dependent may be injected into the stream of decoded instructions. The branch resolution code may be generated using any suitable method, in different embodiments. For example, in some embodiments, the branch resolution code may be generated using hardware circuitry. In other embodiments, the branch resolution code may be generated by the execution, by the processor core, of firmware residing in, or accessible by, the processor core. In still other embodiments, the branch resolution code may be generated using a binary translator or another software translation mechanism that resides in, or is accessible by, the processor core.

At 320, the injected code may be executed to determine a branch direction for the future instance. In at least some embodiments, the injected code may have no side effects. For example, the instructions within the injected code may write only to temporary registers, and the execution of these instructions may affect not affect the primary condition code registers for the processor core (nor any condition code flags thereof). Instead, they may only affect values within temporary registers that represent the primary condition code flags. At 325, the branch direction determined by the execution of the injected code may be stored in an entry of a prediction queue. This prediction queue, sometimes referred to herein as the flakey branch prediction queue (FBPQ) may store one or more predictions for instances of each of multiple branch instructions. In at least some embodiments, the flakey branch prediction queue may store multiple predictions for a branch instruction, each corresponding to a respective instance of the branch instruction in a vector of predictions. Each entry in the flakey branch prediction queue may store a respective prediction vector for a flakey branch instruction associated with a particular address identifier, such as an instruction pointer value or program counter value. In some embodiments, each instance of a flakey branch instruction may correspond to an instance of the flakey branch instruction a respective iteration of a loop.

At 330, subsequent to determining and storing a prediction of the branch direction for the particular future instance of the branch instruction based on execution of the injected branch resolution code, the particular future instance of the branch instruction may be received in the stream of undecoded instructions. An initial branch direction prediction may be determined for this instance by a baseline branch predictor. For example, in one embodiment, a baseline branch predictor may generate an initial prediction of the resolved branch direction based on a global branch history. At 335, since there is an entry for the branch instruction in the flakey branch prediction queue and a valid prediction for the particular future instance of the branch instruction, the initial branch direction prediction may be overridden in favor of the branch direction that was determined by the execution of the injected code and stored in the entry of the prediction queue. The branch direction stored in the entry of the prediction queue may be output by the branch predictor as a final branch direction prediction for the particular future instance of the branch instruction.

FIG. 4 is a block diagram illustrating selected portions of a processor core 400 that implements flakey branch prediction using branch resolution code injection, in accordance with some embodiments of the present disclosure. Although processor core 400 is shown and described as an example in FIG. 4, any suitable mechanism may be used. For example, some or all of the functionality of processor core 400 described herein may be implemented by a digital signal processor (DSP), circuitry, instructions for reconfiguring circuitry, a microcontroller, an application specific integrated circuit (ASIC), or a microprocessor having more, fewer, or different elements than those illustrated in FIG. 4. Processor core 400 may include any suitable mechanisms for performing branch prediction flakey branch prediction using branch resolution code injection. In at least some embodiments, such mechanisms may be implemented in hardware. For example, in some embodiments, some or all of the elements of processor core 400 illustrated in FIG. 4 and/or described herein may be implemented fully or in part using hardware circuitry. In some embodiments, this circuitry may include static (fixed-function) logic devices that collectively implement some or all of the functionality of processor core 400. In other embodiments, this circuitry may include programmable logic devices, such as field programmable logic gates or arrays thereof, that collectively implement some or all of the functionality of processor core 400. In still other embodiments, this circuitry may include static, dynamic, and/or programmable memory devices that, when operating in conjunction with other hardware elements, implement some or all of the functionality of processor core 400. For example, processor core 400 may include a hardware memory having stored therein instructions which may be used to program processor core 400 to perform one or more operations according to some embodiments of the present disclosure. Embodiments of processor core 400 are not limited to any specific combination of hardware circuitry and software. Processor core 400 may be implemented fully or in part by the elements described in FIGS. 1A-2 or FIGS. 9-16.

In the example embodiment illustrated in FIG. 4, processor 400 includes a flakey branch prediction queue 410 and a branch code resolution slice constructor 455. As described in more detail herein, flakey branch prediction queue 410 may include multiple entries, each corresponding to a respective flakey branch instruction. Once such entry is illustrated in FIG. 4. The illustrated entry is indexed within flakey branch prediction queue 410 by an address identifier (such as an instruction pointer value or a program counter value) associated with the flakey branch instruction (shown by the label “FB IP”). The entry stores a vector of branch predictions, each of which includes a predicted branch direction (with a value of T or N, indicating whether the predicted direction is taken or not taken, respectively) and a valid bit (with a value of 0 or 1, indicating whether or not the prediction is valid). There are three pointers associated with each entry in flakey branch prediction queue 410. The branch pointer 424, which is the prediction consumption pointer, points to the prediction for the current instance of the flakey branch instruction (e.g., the current iteration of a loop containing the flakey branch instruction). In other words, branch pointer 424 points to a location within the prediction vector from which a valid prediction for the current instance of the flakey branch instruction is obtained by the branch predictor, if such a prediction exists. In this case, the current instance corresponds to the first position in the prediction vector. This prediction includes a valid bit value of zero, meaning that no valid prediction is stored for the current instance.

The prediction pointer 426 for the flakey branch prediction points ahead (by an arbitrary look-ahead distance) to a prediction for a future instance of the flakey branch instruction. More specifically, prediction pointer 426 points to a location at which a prediction for a future instance of the flakey branch instruction that is generated by branch resolution code injected into the stream of decoded instructions in the neighborhood of the uops for the current instance of the flakey branch instruction is to be written. In at least some embodiments, the distance 416 between the branch pointer 424 and the prediction pointer 426 represents the arbitrary look-ahead distance at which a branch direction prediction for a future instance of the flakey branch instruction is to be made. This distance between branch pointer 424 and prediction pointer 426 may vary for different instances of the flakey branch instruction. However because each flakey branch instruction instance that moves through the processor core pipeline is annotated with the values of both of these pointers, the look-ahead distance at which the branch resolution code injected into the stream of decoded instructions on behalf of the current instance should operate will be known to the branch code resolution slice constructor 455. Therefore, the branch code resolution slice constructor 455 can configure the injected code to generate a prediction for the correct future instance and to store the prediction in the correct location in the flakey branch prediction queue 410.

In some embodiments, a third pointer, shown as retirement pointer 422, may point to a prediction for the next instance of the flakey branch instruction that is to be retired. In other embodiments, a retirement pointer 422 may point to a prediction for the most recently retired instance of the flakey branch instruction.

In some embodiments, as each instruction 425 is received, its address identifier (418) may be compared (at 415) to each of the values in flakey branch prediction queue 410 (provided at 414) to determine if there is a match. If so, this may indicate that the instruction is a flakey branch instruction. In this case, if a valid prediction for this current instance of the flakey branch instruction is found in flakey branch prediction queue 410, a prediction overwrite signal 428 indicating that a valid prediction of the branch direction for the current instance of the flakey branch instruction is available and should override a branch prediction made by baseline branch predictor 430 may be provided to baseline branch predictor 430. The prediction may be obtained (as shown at 432) from the location with the entry for the flakey branch instruction within flakey branch prediction queue 410 pointed to by branch pointer 424. Baseline branch predictor 430 may generate an initial prediction for the instruction 425 based information about the instruction that is provided to baseline branch predictor 430 as 434. A final prediction may be provided to instruction decode queue 435, along with the flakey branch instruction and its annotated pointers, as 436. In some embodiments, baseline branch predictor 430 may be similar to baseline branch predictor 223 illustrated in FIG. 2. In some embodiments, instruction decoder queue 435 may be similar to instruction decoder queue 250 illustrated in FIG. 2. This queue may be where decoded instructions (e.g., uops) reside after decoding and prior to being provided to a processor core back end for execution as 438. In some embodiments, instruction decoder queue 435 may include a decoder, such as decoder 240 illustrated in FIG. 2. In other embodiments, a decoder that provides decoded instructions (e.g., uops) to instruction decoder queue 435 may be separate from instruction decoder queue 435 (not shown in FIG. 4). Each of the entries within instruction decoder queue 435, including an entry representing a flakey branch instruction, may be indexed by an address identifier associated with an instruction that generated the uop (e.g., an instruction pointer value or program counter value).

In the example embodiment illustrated in FIG. 4, processor 400 includes a flakey branch detection table 460, which includes multiple entries, one of which is illustrated in FIG. 4. Each entry of flakey branch detection table 460 may be indexed by an address identifier associated with a particular branch instruction, and may include, for the branch instruction, a count of the number of occurrences of the branch instruction that have retired, and a count of the number of times the branch direction was mispredicted (i.e., the number of associated clear operations). These counts may be determined by information about retired instruction that is received from reorder buffer 440 as input 448. In some embodiments, a branch instruction may be considered to be a flakey branch instruction if a predetermined threshold value for one or both of these counts is exceeded. In this case, an identifier of the detected flakey branch instruction may be provided to branch resolution code slice constructor 455 as input 456. Branch resolution code slice constructor 455 may then generate a branch resolution code slice for resolving branch direction conditions for one or more future instances of the flakey branch instruction. Techniques for generating branch resolution code slices are described in more detail below, according to various embodiments.

Once a branch resolution code slice is generated, it may be recorded in inject code table 450. Each entry within inject code table 450 may be indexed by an address identifier of a respective flakey branch instruction and may include the uops for a branch resolution code slice generated for that flakey branch instruction. When an instruction of a flakey branch instruction for which flakey branch prediction is enabled reaches the instruction decoder queue 435, the branch resolution code slice for that flakey branch instruction that is recorded in inject code table 450 may be injected into the stream of decoded instructions that are presented to the processor core back end for execution as 438, which includes the uops for the flakey branch instruction itself. In at least some embodiments, the branch resolution code slices that are generated by branch code resolution slice constructor 455 may be constructed such that they do not have any side effects. Therefore, the position within the stream of decoded instructions at which they are injected may be somewhat arbitrary. For example, a branch resolution code slice that is injected into a stream of decoded instructions to generate a branch direction prediction for a future flakey branch instruction instance need not be located immediately before or after the uops for a current instance of the flakey branch instruction in the stream of decoded instructions. Instead, it may be injected at any point in the neighborhood of the uops for a current instance of the flakey branch instruction. In some embodiments, the only restriction on the location at which a branch resolution code slice that is injected into a stream of decoded instructions may be that it be on an instruction boundary, in order to avoid being placed in the middle of a microcode flow.

In the example embodiment illustrated in FIG. 4, processor 200 includes various elements of an out-or-order execution engine in the back end of a processor core pipeline, including reorder buffer 440, execution and write back stages 420, and a jump execution unit 445. In some embodiments, a stream of decoded instructions (which may include uops of a branch resolution code slice) may be presented to reorder buffer 440. In some embodiments, reorder buffer 440 may be an element of a register renamer, such as register renamer 261 illustrated in FIG. 2. Decoded instructions stored in reorder buffer 440 may be provided to execution and write back stages 420 as 458. In some embodiments, the decoded instructions may be provided to execution and write back stages 420 by an instruction dispatcher (such as instruction dispatcher 262 illustrated in FIG. 2) and/or through an instruction issue queue (such as one of instruction issue queues 263 illustrated in FIG. 2). Following the execution of a branch resolution code slice, a branch direction prediction for a particular future instance of a flakey branch instruction may be written back to flakey branch prediction queue 410 as prediction information 412.

In some embodiments, reorder buffer 440 may provide information about mispredicted branches, shown as 442, to jump execution unit 445. In some embodiments, in response to a misprediction, jump execution unit 445 may initiate or control an operation to clear uops on the wrong path from the pipeline and to re-steer the processor core front end to the correct path. In addition, if the mispredicted branch instruction is a flakey branch instruction, jump execution unit 445 may provide an indication, shown as 452, to the branch predictor to correct the branch pointer for the mispredicted flakey branch instruction instance. More specifically, this indication may cause the branch pointer for the flakey branch instruction to be rolled back so that it points to the location corresponding to the mispredicted branch as the current instance.

In various embodiments, different combinations of the elements illustrated in FIG. 4 that are involved in flakey branch prediction may be included in a flakey branch predictor in a processor core front end (such as flakey branch predictor 224 illustrated in FIG. 2), in another component within a branch predictor (such as branch predictor 220 illustrated in FIG. 2), in a flakey branch code analyzer and branch resolution code generator in a processor core front end (such as flakey branch code analyzer and branch resolution code generator 255 illustrated in FIG. 2), and/or in various stages of a processor core back end (such as any of the stages shown with processor core back end 260 illustrated in FIG. 2). In general, any or all of these elements may, collectively, be referred to as a flakey branch predictor, or a flakey branch prediction circuit. Logically, this flakey branch prediction circuit may be thought of as being implemented on top of a baseline branch predictor, such as baseline branch predictor 223 illustrated in FIG. 2, or baseline branch predictor 430 illustrated in FIG. 4.

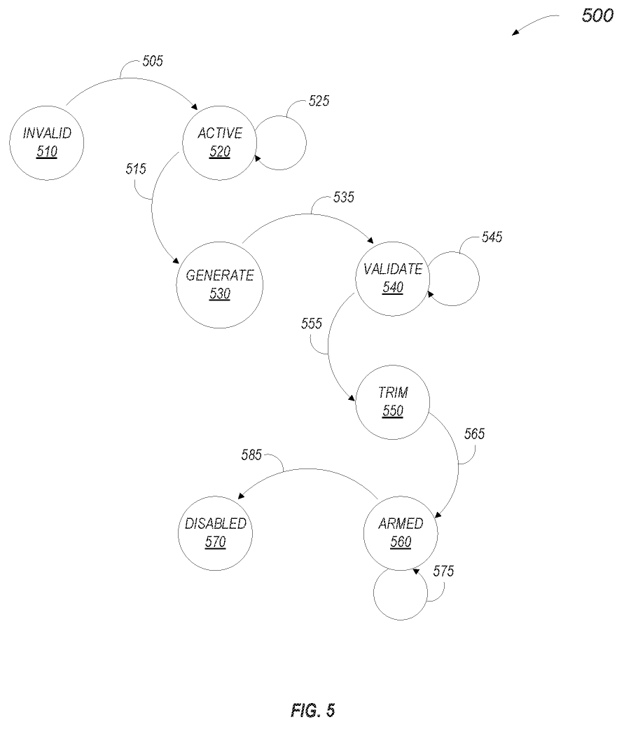

In at least some embodiments, each flakey branch instruction that is handled in a processor core may transition between different stages during its lifetime. In some embodiments, the movement of a flakey branch instruction through these stages may be controlled by a state machine within the processor core. FIG. 5 illustrates a state diagram 500 in which transitions between multiple states of a flakey branch instruction are depicted, in accordance with some embodiments of the present disclosure. In various embodiments, a state machine in accordance with state diagram 500 may be implemented with a flakey branch analyzer or within another component of a processor core that implements flakey branch prediction. In at least some embodiments, a state machine in accordance with state diagram 500 may be implemented in hardware. For example, in some embodiments, some or all of the elements of such a state machine may be implemented fully or in part using hardware circuitry. In some embodiments, this circuitry may include static (fixed-function) logic devices that collectively implement some or all of the functionality of a state machine in accordance with state diagram 500. In other embodiments, this circuitry may include programmable logic devices, such as field programmable logic gates or arrays thereof, that collectively implement some or all of the functionality of a state machine in accordance with state diagram 500. In still other embodiments, this circuitry may include static, dynamic, and/or programmable memory devices that, when operating in conjunction with other hardware elements, implement some or all of the functionality of a state machine in accordance with state diagram 500. For example, a state machine in accordance with state diagram 500 may include a hardware memory having stored therein instructions which may be used to program a processor core to perform one or more operations according to some embodiments of the present disclosure. Embodiments of a state machine in accordance with state diagram 500 are not limited to any specific combination of hardware circuitry and software.

As illustrated in FIG. 5, the initial state of the branch instruction may be an Invalid state 510. In some embodiments, a branch instruction may remain in the Invalid state 510 until an instance of the branch instruction is received for execution in a processor. In other embodiments, a branch instruction may remain in the Invalid state 510 until an instance of the branch instruction retires. In still other embodiments, a branch instruction may remain in the Invalid state 510 until another trigger condition for moving the branch instruction from the Invalid state 510 to an Active state 520 is met. Once a trigger condition for moving the branch instruction from the Invalid state 510 to the Active state 520 is met, the branch instruction may move from the Invalid state 510 to the Active state 520 (as shown by transition 505).

In some embodiments, when the branch instruction moves the Active state 520, a new entry for the branch instruction may be allocated in a flakey branch prediction queue, such as flakey branch prediction queue 410 illustrated in FIG. 4. In some embodiments, the entry may be addressed using an address identifier associated with the branch instruction, such as an instruction pointer value or a program counter value. In some embodiments, when the branch instruction moves the Active state 520, a new entry for the flakey branch instruction may be allocated in a flakey branch detection table, such as flakey branch detection table 460. In some embodiments, the flakey branch detection table may be a hash table whose entries are addressed using an address identifier associated with the branch instruction, such as an instruction pointer value or a program counter value. While the branch instruction remains in the Action state 520, each time an instance of the branch instruction is retired, the counters in the entry of the flakey branch detection table for the branch instruction may be updated accordingly. For example, a count of the number of occurrences of the branch instruction may be incremented and, if the branch direction for the retiring instance of the branch instruction was mispredicted, a count of the number of clears may be incremented, as well. The branch instruction may remain in the Active state 520 until the values of the counters in the entry of the flakey branch detection table for the branch instruction indicate that various criteria for handling the branch instruction using flakey branch prediction have been met. In some embodiments, until the number of occurrences and/or the number of mispredictions for the branch instruction cross a predetermined threshold value, the branch instruction may remain in the Active state 520 (as shown by transition 525).

In one example, a threshold for the number of occurrences of the branch instruction may be specified as an absolute number of occurrences, such as 50. In another example, a threshold for the number of occurrences of the branch instruction may be specified as a number of occurrences within a recent execution window, such as 50 occurrences within the last 10,000 cycles. In some embodiments, a threshold on the number of mispredictions may be specified as a percentage of recent occurrences, which may be calculated as a ratio between the values of the two counters in the entry of the flakey branch detection table for the branch instruction. In one example, the threshold for mispredictions may be set to a rate of 10% of the occurrences of the branch instruction. In another example, the threshold for mispredictions may be set to a rate of 20% of the occurrences of the branch instruction or higher. If the specified thresholds are met, the branch instruction may be considered a flakey branch, and the flakey branch prediction mechanisms described herein may, at least temporarily, be applied when handling the branch instruction. At this point, the flakey branch instruction may move from the Active state 520 to the Generate state 525 (as shown by transition 515).

While the flakey branch instruction is in the Generate state 530, a branch resolution code slice constructor may construct a branch resolution code slice for the flakey branch instruction. For example, the branch resolution code slice constructor may, based on a record of retired uops stored in a history queue, build a dependency chain of uops leading backward from the flakey branch instruction to the uops that affect the resolution of the branch condition on which its branch direction is dependent. For example, the branch resolution code slice constructor may begin with a uop that writes a value to a flag on which the branch condition is dependent and may traverse backward through the history queue identifying logical source-destination register dependencies in the uops that precede the flag writing uop. In at least some embodiments, the branch resolution code slice constructor may maintain a vector of “active” registers (initialized by the required flags only), adding any source registers of uops that write to an active destination register, and disabling the destination registers after doing so. Special treatment may be given to linear operations in which a destination register is also one of the source registers (or to longer chains with cyclic dependencies), since they may be updating the loop induction variable, and may allow the branch resolution code slice constructor to learn of any stride.

In some embodiments, the history queue may reside in a retirement stage of the processor core back end. In some embodiments, the history queue may store data representing retired uops in a circular queue that stores data representing the most recently retired uops. For example, history queue may store address identifiers (such as instruction pointer values or program counter values) for the 32 or 64 most recently retired uops. In at least some embodiments, the traversal of the history queue need not be performed immediately after the flakey branch instruction moves to the Generate state 530, nor does it need to be completed within a predetermined time period or number of cycles. Instead, a state machine or a separate parallel process may be used to generate the branch resolution code slice for the flakey branch instruction. An example of the generation of a branch resolution code slice is described in detail below.

Once the branch resolution code slice for the flakey branch instruction has been generated, the flakey branch instruction may move from the Generate state 525 to the Validate state 540 (as shown by transition 535). In some embodiments, in order to fully qualify as a flakey branch, the branch resolution code generation process must be complete and must find that there is some data dependency with respect to the condition on which the branch direction is dependent. Note that not all branches that begin the branch resolution code generation process complete the process and move to the Validate state 540.

When an instance of the flakey branch instruction is received while the flakey branch instruction is in the Validate state 540, the branch resolution code may be validated. For example, while the flakey branch instruction is in the Validate state 540, the branch resolution code slice constructor may confirm (over a configurable number of iterations) that the code on which generation of the branch resolution code slice was generated slice is invariant, both in code and in stride values. For example, the validation may include determining that each uop in the history queue leading up to a flakey branch instruction instance is consistent with a corresponding uop that was in the history queue when the branch resolution code was generated. If the code is different, this may indicate that the code flow in the neighborhood of at least some instances of the flakey branch instruction differs. Thus, the generated branch resolution code cannot be used to predict a branch direction for a future instance of the branch instruction. In this case, the entry for the flakey branch instruction in the inject code table may be reset. If, for a given uop in the branch resolution code slide, the same uop in the history queue has a stride of zero, the stride may be populated. In this case, this would be the second time the flakey branch instruction has been reached and the data to populate the stride is now known. This data may include an address or another value that is not known until the second time the flakey branch instruction is reached. If, for a given uop in the branch resolution code slide, it is determined (e.g., in a second validation operation, based on the history queue) that the stride varies, the uop may be marked as being a non-strided uop. Once a predetermined number of validation operations, N, has been successfully completed, with the branch resolution code being confirmed to be invariant, the flakey branch instruction may move from the Validate state 540 to the Trim state 550 (shown as transition 555). In some embodiments, the number of validation operations, N, may be configurable during runtime. In one embodiment, N may be 10.

While the flakey branch instruction is in the Trim state 550, the branch resolution code slice constructor may remove any unused (or unneeded) uops from the branch resolution code slice. For example, some uops may no longer be needed in the branch resolution code slice once they have a stride. The branch resolution code slice constructor may detect the eventual stride generators, and may remove their source dependencies from the branch resolution code slice. Once this trimming is complete, the flakey branch instruction may move from the Trim state 550 to the Armed state 560 (shown as transition 565).

Once the flakey branch instruction is in the Armed state 560, an address identifier associated with the flakey branch (such as an instruction pointer value or program counter value) may be recorded along with the uops that make up the branch resolution code slice (e.g., in an inject code table such as inject code table 450 illustrated in FIG. 4). At this point, flakey branch prediction for the flakey branch instruction is ready to be triggered. For example, the entry within the flakey branch prediction queue for the flakey branch instruction may be armed for the application of flakey branch prediction. As previously noted, each entry of the flakey branch prediction queue may correspond to branch instructions associated with a single address identifier (an instruction pointer value or program counter value). Each entry may hold a vector of branch direction predictions (e.g., taken or not taken) for future iterations of the branch instruction, along with a corresponding valid bit for each prediction.

In some embodiments, while the flakey branch instruction remains in the Armed state 560 (as shown by transition 575), as each instance of the flakey branch instruction is received, a prediction stored in the flakey branch prediction queue for the particular instance, if one exists, may be output as the branch prediction for the flakey branch instruction instance. As each flakey branch instruction instance moves through the processor core front end, the branch resolution code generated for the flakey branch instruction may be injected into the decoded instruction stream, after which it may be executed to resolve the branch directions for one or more future instances of the flakey branch instruction.

In some embodiments, if the flakey branch prediction mechanisms do not meet performance criteria for the flakey branch instruction (e.g., if there the number of mispredictions for the flakey branch is higher than a predetermined threshold value or if mispredictions occur at a rate that exceeds a predetermined threshold value), the flakey branch instruction may move from the Armed state 560 to the Disabled state 570 (as shown by transition 585). The flakey branch instruction may remain, at least temporarily, in the Disabled state 570 in order to avoid attempting to apply the flakey branch prediction techniques to a branch instruction for which it has not been shown to be beneficial. In some embodiments, if the workload or other conditions change, the flakey branch instruction may be moved from the Disabled state 570 back to the Invalid state 510, which may allow for the possibility of re-enabling flakey branch prediction for the flakey branch instruction at some point in the future.

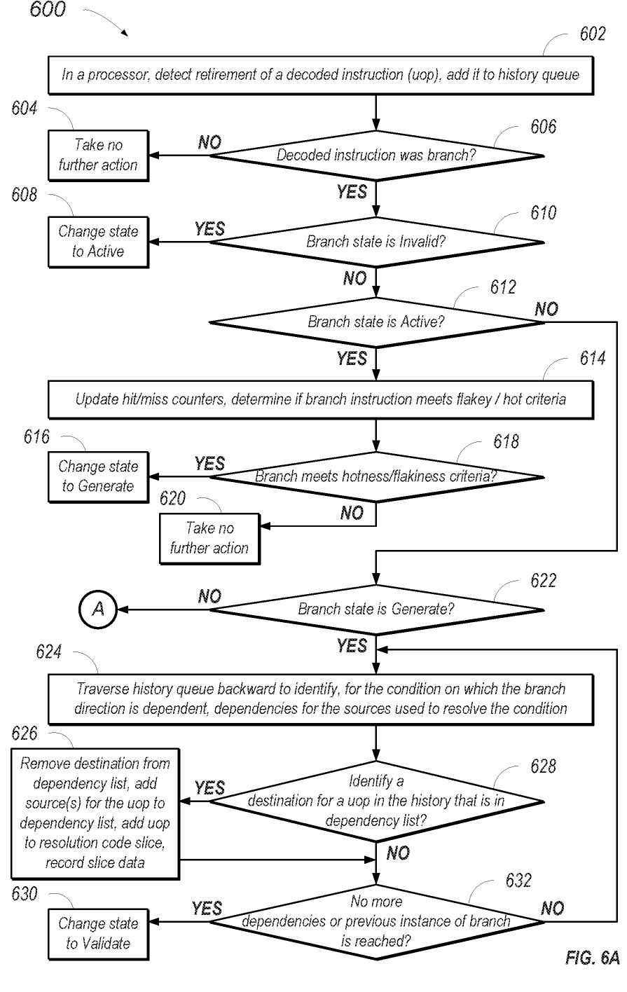

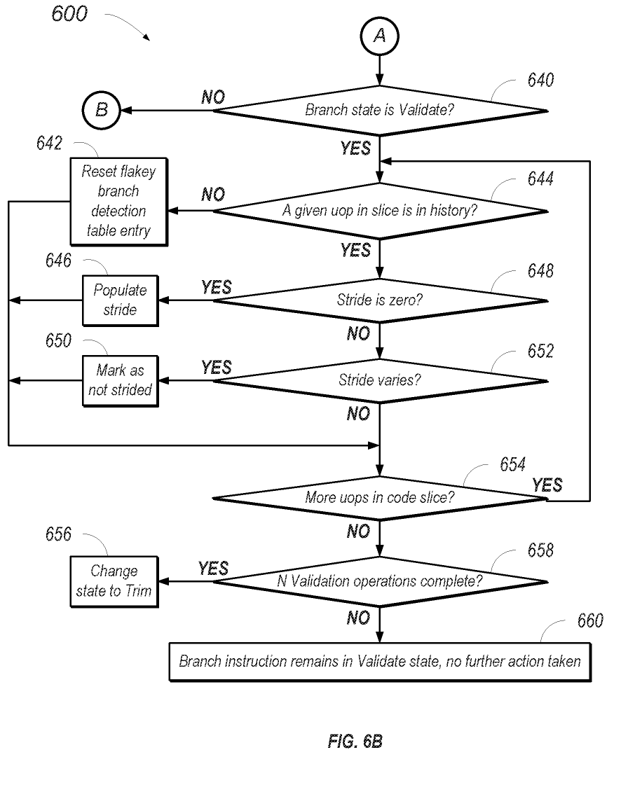

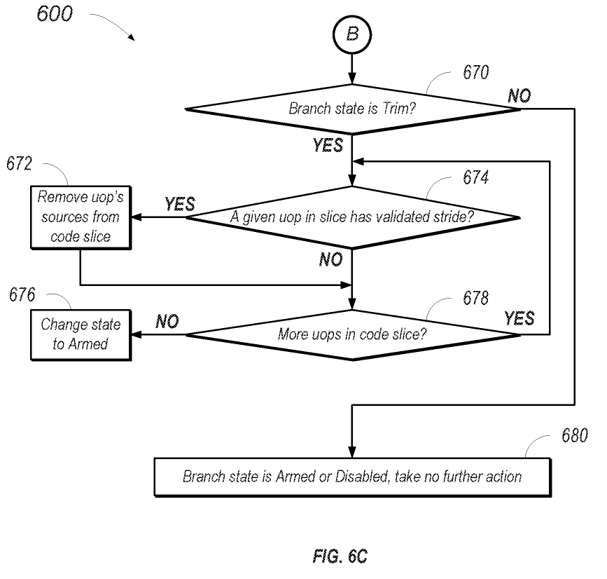

FIGS. 6A-6C are flow diagrams illustrating a method 600 for performing flakey branch prediction, in accordance with at least some embodiments of the present disclosure. Method 600 may be implemented by any of the elements shown in FIGS. 1-5, or in FIGS. 9-16. In some embodiments, method 600 may be implemented by hardware circuitry, which may include any suitable combination of static (fixed-function), dynamic, and/or programmable logic devices. In other embodiments, one or more of the operations of method 600 may be performed or emulated by the execution of program instructions. Method 600 may be initiated by any suitable criteria and may initiate operation at any suitable point. In one embodiment, method 600 may initiate operation at 602. Method 600 may include greater or fewer operations than those illustrated. Moreover, method 600 may execute its operations in an order different than those illustrated in FIGS. 6A-6C. Method 600 may terminate at any suitable operation. Moreover, method 600 may repeat operation at any suitable operation. Method 600 may perform any of its operations in parallel with other operations of method 600, or in parallel with operations of other methods. Furthermore, method 600 may be executed multiple times to perform flakey branch prediction for different flakey branch instructions and different flakey branch instruction instances. During the execution of method 600, other methods may be invoked. In some embodiments, method 600 may be invoked to perform at least some of the operations of method 300 illustrated in FIG. 3.

At 602, in one embodiment, the retirement of a decoded instruction (uop) may be detected in a processor, and may be added to a history queue of uops. In some embodiments all retired uops may be added to the history queue. In other embodiments, the amount of information added to the history queue may be limited or optimized to save space by refraining from storing retired uops that are not likely to be needed by the branch predictor or other components of the processor core.

If, at 606, it is determined that the decoded instruction was not a branch instruction, no further action may be taken with respect to flakey branch prediction, as in 604. If, at 606, it is determined that the decoded instruction was a branch instruction, and if, at 610, it is determined that the state of the branch is Invalid, the state of the branch may be changed to Active, as in 608. In one embodiment, there may be no entry in the flakey branch prediction queue (FBPQ) for a branch instruction in the Invalid state. However, when the retirement of such an instruction is detected and its state is changed to Active, an entry may be allocated in the FBPQ for that branch instruction.

Alternatively, if, at 612, it is determined that the state of the branch is Active, hit/miss counters for the instruction may be updated, and a determination may be made as to whether the branch instruction meets various criteria for handling using flakey branch prediction, as in 614. In some embodiments, determining whether or not a branch instruction should be handled using flakey branch prediction may include determining how many instances of the branch instruction were retired and for how many of the retired instances of the branch instruction the branch direction was mispredicted. For example, in one embodiment, at retirement, information may be stored in a hash table (such as flakey branch detection table 460 illustrated in FIG. 4) indicating a running count of the number of occurrences of the branch instruction (the number of hits for the branch instruction) and a running count of the number of times the branch direction was mispredicted (the number of clear operations for the branch instruction). In some embodiments, in order to focus the flakey branch prediction resources on the branch instructions that are most likely to benefit from this approach, only branch instructions whose running count of the number of occurrences of the branch instruction and running count of the number of times the branch direction was mispredicted meet predetermined minimum thresholds may be handled using the flakey branch prediction mechanisms described herein. In some embodiments, one or both of these thresholds may be configurable. If these two predetermined minimum thresholds for branch instruction “hotness” and “flakiness” are met, the branch instruction may be marked for branch resolution code slice generation. For example, if, at 618, it is determined that the branch instruction meets predetermined “hotness” and “flakiness” criteria, the state of the branch instruction may be changed to Generate, as in 616. If not, no further action may be taken for this branch instruction with respect to flakey branch prediction, as in 620.

If, at 612, it is determined that the state of the branch instruction is not Active, method 600 may continue at 622. If at 622, it is determined that the state of the branch instruction is Generate, the history queue may be traversed backward to identify, for the condition on which the branch direction is dependent, dependencies for the sources used to resolve the condition, as in 624. At 628, if a destination for a uop in the history queue that is in a dependency list for the branch condition is identified, method 600 may proceed to 626, after which it may continue at 632. Otherwise, method 600 may proceed directly to 632. At 626, the destination may be removed from the dependency list, the source(s) for the uop may be added to dependency list, the uop may be added to the branch resolution code slice, and branch resolution code slice data may be recorded (e.g., in code inject table 450). If, at 632, it is determined that there are no additional dependencies to be tracked, or if a previous instance of the branch instruction is reached in the history queue, the branch resolution code slice may be finalized and the state of the branch instruction may be changed to Validate. In some embodiments, finalizing the branch resolution code slice may include replacing the branch instruction with an FBPQ push operation to write the branch direction determined through the resolution of the conditions on which the branch direction for the flakey branch instruction instance is dependent to the FBPQ. However, if, at 632, it is determined that there are more dependencies to be addressed and if no previous instance of the branch instruction has been reached in the history queue, method 600 may return to 624, where it may repeat some or all of the operations shown as 624-632 one or more times, as appropriate, until the conditions evaluated at 632 resolve as True.

If, at 622, it is determined that the state of the branch instruction is not Generate, method 600 may continue at label A in FIG. 6B. If, at 640, it is determined that the state of the branch instruction is not Validate, method 600 may continue at label B in FIG. 6C. However, if it is determined that the state of the branch instruction is Validate, method 600 may continue at 644, where a validation of a previously generated branch resolution code slice for the branch instruction may begin. If, at 644, it is determined that a given uop in the branch resolution code slice is not found in the history queue, the flakey branch detection table entry for the branch instruction may be reset, as in 642, after which method 600 may continue at 654. However, if it is determined that the given uop in the branch resolution code slice is found in the history queue, method 600 may continue at 648.

If at 648, it is determined that the stride for the given uop is zero, the stride may be populated, as in 646, after which method 600 may continue at 654. For example, the stride may be determined as the distance between the branch pointer and the prediction pointer with which the branch instruction instance is annotated. However, if it is determined that the stride for the given uop is not zero, method 600 may continue at 652

If at 652, it is determined that the stride for the given uop varies, the branch instruction may be marked as not strided, as in 642, after which method 600 may continue at 654. However, if it is determined that the stride for the given uop does not vary, method 600 may continue directly to 654. If, at 654, it is determined that there are no additional uops in the branch resolution code slice to be validated, method 600 may continue at 658. If, however, at 654, it is determined that there are additional uops in the branch resolution code slice to be validated, method 600 may return to 644. Method 600 may then repeat some or all of the operations shown as 642-652 one or more times, as appropriate, until there are no additional uops in the branch resolution code slice, after which method 600 may continue at 658. At 658, if a predetermined number of validation operations (shown as N) have been completed for the branch instruction, the state of the branch instruction may be changed to Trim, as in 656. Otherwise, the branch instruction may remain in the Validate state, and no further action may be taken for this branch instruction with respect to flakey branch prediction, as in 660.

Continuing at label B in FIG. 6C, if, at 670, it is determined that the state of the branch instruction is not Trim, then the state of the branch instruction may be either Armed or Disabled. In either case, method 600 may proceed to 680, where there may be no further action taken for this branch instruction with respect to flakey branch prediction. However, if, at 670, it is determined that the state of the branch instruction is Trim, method 600 may continue at 674, where an operation to at least attempt to trim the branch resolution code slice may begin. If, at 674, it is determined that a given uop in the branch resolution code slice has a validated stride, method 600 may proceed to 672. At 672, the sources for the uop may be removed from code slice, after which method 600 may continue at 678. If, at 674, it is determined that the given uop in the branch resolution code slice does not have a validated stride, method 678 may proceed directly to 678.

If, at 678, it is determined that there are no additional uops in the branch resolution code slice that may potentially be trimmed, method 600 may continue at 676. If, however, at 678, it is determined that there are additional uops in the branch resolution code slice to be considered for trimming, method 600 may return to 674. Method 600 may then repeat some or all of the operations shown as 672-674 one or more times, as appropriate, until there are no additional uops in the branch resolution code slice, after which method 600 may continue at 676. At 676, following completion of the trim operation, the state of the branch instruction may be changed to Armed. In some embodiments, once the branch resolution slice code is prepared, the branch instruction may be armed by writing an address identifier (such as an instruction pointer value or program counter value) for the branch instruction into an entry that was allocated for the branch in the FBPQ. In some embodiments, writing the address identifier into the FBPQ entry may enable this flakey branch instruction for handling using flakey branch prediction. For example, this may trigger the generation of branch direction predictions for future instances of the branch instruction. In some embodiments, each entry in the FBPQ may store a vector of branch direction predictions for future instances, which may be used as a cyclic queue. As previously noted, each of the future predictions in the vector may include a single prediction bit to indicate whether the determined branch direction is taken or not taken, and a valid bit indicating whether or not the value of the prediction bit is valid. In some embodiments, all of the prediction bits are initially invalid. Therefore all of the valid bits are initialized to zero. As the prediction bits are populated by the execution of branch resolution code slices for different future instances of the branch instruction, the corresponding valid bits may be set (enabled).

The techniques described herein for performing flakey branch prediction may be further illustrated by way of the following example. In this example, following the identification of flakey branch instruction, a branch resolution code slice is generated for a portion of the instruction stream that includes and precedes the flakey branch instruction. In various embodiments, this branch resolution code slice may be constructed by a hardware mechanism within the processor core, or through binary analysis methods that evaluate and modify the instructions within the instruction stream in real time. In this example, the illustrated code sample is shown as x86 code, and it includes a flakey branch instruction at line 0x10007 and a flow control branch instruction, which always jumps back to the beginning of the loop until the loop ends, at line 0x1000b.

0x10000: addl $0x4, % edx

0x10003: movl (% edx), % eax

0x10005: testl % eax, % eax

0x10007: je 0x1000b

0x10009: . . .

0x1000b: je 0x10000

In this example, the following branch resolution code slice is generated for injection into the decoded instruction stream. The branch resolution code slice is illustrated as microcode-equivalent pseudo code.

Tmp8=Add $0x40, edx

Tmp9=Load [Tmp8]

TmpFlags=And Tmp8, Tmp9

Push_FBPQ (TmpFlags)

In this example, the flakey branch instruction at line 0x10007 in the code sample will be replaced in the branch resolution code slice by a push of the resolved branch direction from a temporary flag register to a location within an entry in the FBPQ for the instruction identified by the prediction pointer with which the flakey branch instruction was annotated. The flakey branch instruction at line 0x10007 is dependent on the value of the eax register, which was read from memory at line 0x10003. In this example, the pointer (edx) that is used to identify the location in memory from which to read the value into the eax register is incremented by four each time the instructions within this code sample are executed (e.g., on each iteration of the illustrated loop). In this example, on each iteration of the loop, the instructions within this code sample read the value of a respective element in an array of data, and checks the value to determine whether it is zero or a non-zero value. This code sample may, in some applications, be used to count how many zeros (or non-zero values) are present in an array. Since the data in the array, and the order in which it is to be accessed, might not be known or predictable prior to runtime, the flakey branch may appear to be taken or not taken randomly for different instances (iterations) of the flakey branch instruction.

In order to generate the branch resolution code slice for the code sample, a branch resolution code slice constructor may traverse the code sample backward from the point of the flakey branch looking for instructions (or uops) that affect the resolution of the direction for the flakey branch instruction. In this example, the direction of the flakey branch instruction is dependent on the outcome of a test (at line 0x10005) to determine whether two values are “equal”. Thus, the branch direction depends on the value of a zero flag. The branch resolution code slice constructor may traverse the code sample backward to determine which uops affect the setting of the zero flag. The uop shown at line 0x10005 would, when executed, result in a write to the zero flag. Therefore, an operation equivalent to this operation, but targeting a temporary register, is added to the branch resolution code slice. Since the uop shown at line 0x10005 consumes the value of the eax register, the eax register is marked as a register on which there is a live dependency, and the traversing of the code sample continues. The uop shown at line 0x10003 writes to the eax register. Therefore, an operation equivalent to this uop, but targeting temporary registers, is also added to the branch resolution code slice. In this example, an operation equivalent to the uop shown at line 0x10000 may also be added to the branch resolution code slice because the load operation at line 0x10003 depends on the value written to the edx register by the add operation at line 0x10000. Once generation of the branch resolution code slice is complete, the uops in the branch resolution code slice code slice may be recorded in a structure that resides in the processor core front end, such as inject code table 450 illustrated in FIG. 4.

In this example, execution of the branch resolution code slice has no side effects, except for writing the resolved branch direction to the location corresponding to a particular future instance of the flakey branch instruction in the FBPQ entry for the flakey branch instruction. More specifically, the execution of the branch resolution code slice does not affect the program flow of the original instruction stream nor does it change the value of any registers accessed by the instructions of the original instruction stream. Note, however, that in the branch resolution code slice, instead of incrementing the pointer (edx) by four in this iteration, the value of the pointer edx is incremented according to the look-ahead distance of the future iteration for which the branch resolution code slice will determine the branch direction and the stride. The amount by which to increment the pointer, in this example, may be equal to the look-ahead distance multiplied by the stride. In this case, the pointer value is incremented by a look-ahead distance of 0x40 (corresponding to 16 iterations into the future). When the branch resolution code slice is subsequently executed, it takes the current value of the edx pointer, adds the look-ahead distance, loads the value identified by the incremented pointer into a temporary register (TMP9), and effectively tests the value to see if it is zero or non-zero by performing an AND operation that sets a temporary flag to a value indicating whether or not the value in TMP9 is zero. The Push_FBPQ uop pushes the resolved branch direction for this branch iteration (as indicated by the value of the temporary flag) into the FBPQ. When the flakey branch instruction that is sixteen iterations in to the future is received, the value pushed to the FBPQ rather than a branch prediction generated by a baseline branch predictor, may be used as the predicted branch direction.

As noted above, construction of a branch resolution code slice may be performed by dedicated external code (e.g., by a long assist flow or an underlying binary-translator or optimizer layer), or by a hardware mechanism, in different embodiments. In other embodiments, construction of a branch resolution code slice may be performed by firmware that resides in, or is accessible by, the processor core. In some embodiments, in the case that multiple nested branch instructions are detected in a single loop context, a branch resolution code slice may be generated for each such branch instruction. These branch resolution code slices may be injected into the executing instruction stream independently, but may share the same branch pointer. In this case, each branch instruction will produce predictions for all iterations, but a dependent branch instruction may not consume all of its predictions, since the identifier of the dependent branch instruction will not be hit in the FBPQ on all iterations. Instead, the leading branch of the nested structure may promote the branch pointer so that it will continue reflecting the actual loop iteration.

In at least some embodiments of the present disclosure, for every branch prediction unit (BPU) lookup performed at the beginning of the processor pipeline for every new address identifier associated with an instruction (such as an instruction pointer value or program counter value), a lookup into the FBPQ may be performed in parallel. If there is a hit in the FBPQ on a valid entry, and if the branch pointer for that entry points at a prediction with a valid bit set to 1, the BPU prediction for that branch instruction instance may be overridden with the FBPQ prediction found at the location within the entry pointed to by the branch pointer. If the prediction is not valid, it may be ignored.

In at least some embodiments, after “consuming” a prediction from the FBPQ (regardless of whether or not it was valid), the branch pointer may be incremented to point to the prediction for the next iteration. The prediction pointer may be incremented to point to the next iteration to be predicted, which may be within a pre-determined look-ahead distance.

In at least some embodiments, each branch instruction that passes through the processor pipeline may be annotated with the branch pointer value and the prediction pointer value as they were sampled at the time of the FBPQ lookup. Note that, in the case of a hit, the post increment value may be used for the prediction pointer value. In the case that the branch direction is mispredicted, the branch pointer value may be sent back to the FBPQ in parallel with an effort to re-steer the processor core to the correct path. The branch pointer value that is sent back to the FBPQ may be used to reset the branch pointer to point to the next branch instruction instance (or iteration) following the clear operation.

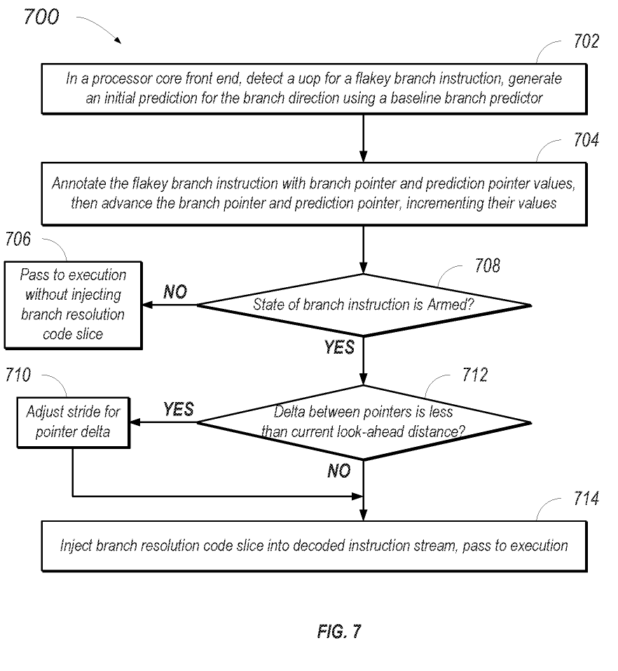

FIG. 7 is a flow diagram illustrating a method 700 for handling a flakey branch instruction in a processor core front end, in accordance with at least some embodiments of the present disclosure. Method 700 may be implemented by any of the elements shown in FIGS. 1-5, or in FIGS. 9-16. In some embodiments, method 700 may be implemented by hardware circuitry, which may include any suitable combination of static (fixed-function), dynamic, and/or programmable logic devices. In other embodiments, one or more of the operations of method 700 may be performed or emulated by the execution of program instructions. Method 700 may be initiated by any suitable criteria and may initiate operation at any suitable point. In one embodiment, method 700 may initiate operation at 702. Method 700 may include greater or fewer operations than those illustrated. Moreover, method 700 may execute its operations in an order different than those illustrated in FIG. 7. Method 700 may terminate at any suitable operation. Moreover, method 700 may repeat operation at any suitable operation. Method 700 may perform any of its operations in parallel with other operations of method 700, or in parallel with operations of other methods. Furthermore, method 700 may be executed multiple times to handle different flakey branch instructions and different flakey branch instruction instances in the front end of a processor. During the execution of method 700, other methods may be invoked. In some embodiments, method 700 may be invoked to perform at least some of the operations of method 300 illustrated in FIG. 3.

At 702, in one embodiment, a uop for a flakey branch instruction may be detected in a processor core front end, and an initial prediction for the branch direction may be generated using a baseline branch predictor. At 704, the flakey branch instruction may be annotated with branch pointer and prediction pointer values, after which the branch pointer and prediction pointer values may be advances, e.g., by incrementing their values.

At 708, it may be determined whether the state of the branch instruction is Armed. If so, method 700 may continue at 712. Otherwise method 700 may proceed to 706. At 706, the annotated branch instruction may be passed to the execution stage of the processor core without injecting a branch resolution code slice. At 712, it may be determined whether distance between the branch pointer and the prediction pointer for this instance (or iteration) is less than the current look-ahead distance. If not, method 700 may continue at 714. If so, method 700 may proceed to 710, after which it may continue at 714. At 710, The stride may be adjusted in accordance with the distance between the pointers. At 714, the branch resolution code slice may be injected into the decoded instruction stream, and passed to the processor core back end for execution.

In at least some embodiments of the present disclosure, when a flaky branch instruction reaches the instruction decoder queue of a processor core (such as instruction decoder queue 435 illustrated in FIG. 4) and matches the address identifier associated with its corresponding branch resolution slice code (which may be stored in an inject code table, such as inject code table 450 illustrated in FIG. 4), the instruction decoder queue may stall the normal flow of uops and inject the branch resolution slice code into the executing code stream. At that point, the actual look-ahead distance may be calculated according to the distance between the branch pointer and the prediction pointer with which the branch instruction for the current iteration is annotated. This delta between the two pointers may reflect the desired distance between the current iteration being fed into the processor core back end for execution, and the future iteration for which a branch direction prediction is desired. The branch resolution slice code that is actually injected into the executing code stream may be modified to extrapolate the stride into the desired look-ahead distance. In at least some embodiments, the injected branch resolution slice code may then be executed in the processor core back end (which may be an out-of-order machine), concluding with the execution of a FBPQ_push operation. The injected branch resolution slice code may compute the outcome of the branch condition using the data obtained for the future iteration. The injected code may then write the outcome (e.g., data indicating whether the future branch direction is taken or not taken) based on the original branch type and the flag values on which the branch direction depends, into the FBPQ at the location pointed to by the prediction pointer with which the branch instruction for the current iteration is annotated.

As noted above, in some embodiments, in the case of a misprediction (of a flaky branch instruction or of an unrelated branch instruction), the branch pointer of that branch instruction may be sent back to the processor core front end to reset the branch pointer stored there while, in parallel, operations on the wrong path are cleared and the processor core front end is re-steered to the correct path. If the direction for the flaky branch itself is mispredicted, its branch pointer may be set to point at the next iteration (since the mispredicted iteration may still commit, unless there is a misprediction for an older branch later on). On the other hand, the prediction pointer might not be reset, since some of the entries may have already executed and may still be salvaged from the wrong path (assuming the clear does not change the loop control flow). Instead, the prediction pointer may be set back only to a value pointing to an earlier non-valid prediction in the prediction vector for the branch instruction, so it may continue predicting the branch directions for future iterations beginning at that point. This different treatment of the branch pointer and the prediction pointer may result in varying distances between the pointer. In some embodiments, in order to re-converge on a desired look-ahead distance, different numbers of instances of the branch resolution slice code (such as zero or two instances) may be injected into the executing code stream rather than a single instance, if the distance is larger or smaller (respectively) than the desired look-ahead distance. In either case all of the pointers may be updated accordingly.

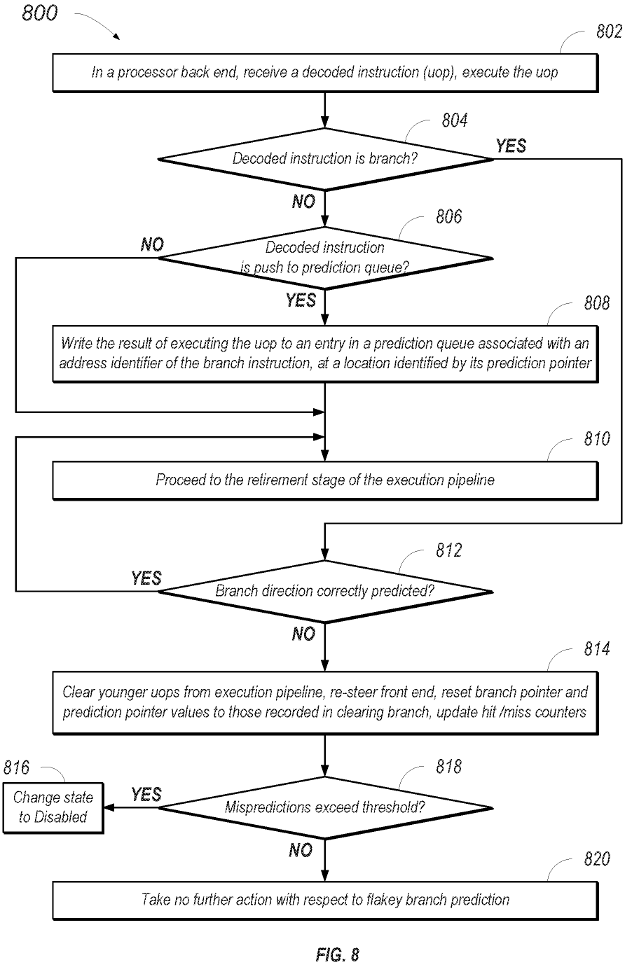

FIG. 8 is a flow diagram illustrating a method 800 for executing decoded instructions, including flakey branch instructions, in accordance with at least some embodiments of the present disclosure. Method 800 may be implemented by any of the elements shown in FIGS. 1-5, or in FIGS. 9-16. In some embodiments, method 800 may be implemented by hardware circuitry, which may include any suitable combination of static (fixed-function), dynamic, and/or programmable logic devices. In other embodiments, one or more of the operations of method 800 may be performed or emulated by the execution of program instructions. Method 800 may be initiated by any suitable criteria and may initiate operation at any suitable point. In one embodiment, method 800 may initiate operation at 802. Method 800 may include greater or fewer operations than those illustrated. Moreover, method 800 may execute its operations in an order different than those illustrated in FIG. 8. Method 800 may terminate at any suitable operation. Moreover, method 800 may repeat operation at any suitable operation. Method 800 may perform any of its operations in parallel with other operations of method 800, or in parallel with operations of other methods. Furthermore, method 800 may be executed multiple times to execute different instructions, including different flakey branch instructions and different flakey branch instruction instances. During the execution of method 800, other methods may be invoked. In some embodiments, method 800 may be invoked to perform at least some of the operations of method 300 illustrated in FIG. 3.

At 802, in one embodiment, a decoded instruction (uop) may be received in a processor back end, and may be executed. At 804, it may be determined whether the decoded instruction is a branch instruction. If so, method 800 may proceed to 812. Otherwise, method 800 may continue at 806. At 806, it may be determined whether the decoded instruction is an operation to push a branch resolution result to the flakey branch prediction queue (FBPQ). For example, the decoded instruction may be an FBPQ push operation in a branch resolution code slice. If so, method 800 may proceed to 808. Otherwise, method 800 may proceed to 810. At 808, the result of executing the FBPQ push uop may be written to an entry in the prediction queue (FBPQ) that is associated with an address identifier of the branch instruction. More specifically, the result may be written to a location within the entry that is identified by the prediction pointer for the branch instruction. At 810, the branch instruction may proceed to the retirement stage of the execution pipeline

At 812, it may be determined whether the branch direction was correctly predicted. if so, method 800 may proceed to 810. Otherwise, method 800 may continue at 814. In response to the misprediction, at 814, any younger uops may be cleared from the execution pipeline, the front end of the processor core may be re-steered, the branch pointer and prediction pointer values may be reset to the values recorded in the clearing branch, and the hit/miss counters for the branch instruction may be updated. At 818, it may be determined whether the number of mispredictions for this branch instruction has exceeds a maximum misprediction threshold. If so, method 800 may continue at 816. Otherwise, no further action may be taken for the instruction with respect to flakey branch prediction, as in 810. At 816, the state of the branch instruction may be changed to Disabled.

In some embodiments of the present disclosure, a processor core may include a dynamic performance evaluation mechanism to determine, for each flakey branch prediction, whether injecting branch resolution code to predict the branch direction for future iterations results in performance benefits that outweigh the cost of executing the additional instructions in the injected code. For example, a dynamic performance evaluation mechanism may track, over time, and compare the number of branch direction mispredictions incurred for a given branch instructions when branch resolution code associated with the given branch instruction is injected into the executing code stream and when no such code is injected into the executing code stream. If and when it appears that any reduction in the number of branch direction mispredictions is small enough that executing the injected branch resolution code is not justified, the dynamic performance evaluation mechanism may take action to refrain from injecting branch resolution code associated with the given branch instruction. For example, in one embodiment, after determining that branch resolution code associated with a given branch instruction should not be injected into the executing code stream, the dynamic performance evaluation mechanism may, at least temporarily, change the state of the given branch instruction to Disabled. In some embodiments, after disabling flakey branch prediction for a given branch instruction and allowing a predetermined amount of time to pass, the state of the given branch instruction may be changed from Disabled to Invalid, which may allow for the possibility of re-enabling flakey branch prediction for the given branch instruction at some point in the future. Disabling flakey branch prediction for a given branch instruction may not affect the application of flakey branch prediction to one or more other flakey branch instructions.

In some embodiments, the overhead introduced by the flakey branch prediction mechanisms described herein may be amortized by the use of vector operations. For example, the injected branch resolution code may be configured to resolve the respective branch directions for multiple future iterations, rather than for a single future iteration. In this example, one or more of the operations within the branch resolution code slice may be vector operations that operate on the date for multiple future iterations in parallel. These vector operations may include vector reads to obtain the data upon which the branch directions for multiple branch instances depend, vector compare operations to evaluation the branch conditions for multiple branch instances, or vector write operations to push the results to the FBPQ.

Unlike existing branch prediction solutions, the techniques described herein may be able to predict the branch directions for branch instructions whose branch conditions are data-dependent. Modeling of these techniques using a timing-accurate simulator has shown performance gains of more than two times the speed for loops that include branch instruction with data-dependent branch conditions, leading to an estimated overall performance gain of over 2% (on average) for a wide variety of applications. Based on simulator results, it is expected that 10% or more of branch mispredictions may be addressed using flakey branch prediction, as described herein.

The figures described below include detailed examples of architectures and systems to implement embodiments of the hardware components and/or instructions described above. In some embodiments, one or more hardware components and/or instructions described above may be emulated as described in detail below, or may be implemented as software modules.

### Example Core Architectures, Processors, and Computer Architectures

Processor cores may be implemented in different ways, for different purposes, and in different processors. For instance, in various embodiments, such cores may include a general purpose in-order core intended for general-purpose computing, a high-performance general purpose out-of-order core intended for general-purpose computing, and/or a special purpose core intended primarily for graphics and/or scientific computing (e.g., high throughput computing). In various embodiments, different processors may include a CPU, including one or more general purpose in-order cores intended for general-purpose computing and/or one or more general purpose out-of-order cores intended for general-purpose computing, and a coprocessor, including one or more special purpose cores intended primarily for graphics and/or scientific computing (e.g., high throughput computing). Such different processors may lead to different computer system architectures, in different embodiments. For example, in some embodiments, a coprocessor may be on a separate chip than a CPU. In other embodiments, a coprocessor may be on a separate die than a CPU, but may be in the same package as the CPU. In some embodiments, a coprocessor may be on the same die as a CPU. In this case, the coprocessor may sometimes be referred to as special purpose logic, which may include integrated graphics and/or scientific logic (e.g., high throughput logic), or as a special purpose core. In some embodiments, a system on a chip may include, on the same die, a CPU as described above (which may be referred to as the application core(s) or application processor(s)), a coprocessor as described above, and additional functionality. Example core architectures, processors, and computer architectures are described below, according to some embodiments.

### Example Core Architectures

### In-Order and Out-of-Order Core Block Diagram

FIG. 9A is a block diagram illustrating an example in-order pipeline and a register renaming, out-of-order issue/execution pipeline, according to some embodiments. FIG. 9B is a block diagram illustrating an in-order architecture core and register renaming, out-of-order issue/execution logic to be included in a processor, according to some embodiments. The solid lined boxes in FIG. 9A illustrate the in-order pipeline, while the dashed lined boxes illustrate the register renaming, out-of-order issue/execution pipeline. Similarly, the solid lined boxes in FIG. 9B illustrate the in-order architecture logic, while the dashed lined boxes illustrate the register renaming logic and out-of-order issue/execution logic

In FIG. 9A, a processor pipeline 900 includes a fetch stage 902, a length decoding stage 904, a decode stage 906, an allocation stage 908, a renaming stage 910, a scheduling stage 912 (also known as a dispatch or issue stage), a register read/memory read stage 914, an execution stage 916, a write back/memory write stage 918, an exception handling stage 922, and a commit stage 924.

In FIG. 9B, arrows denote a coupling between two or more units and the direction of the arrow indicates a direction of data flow between those units. In this example, FIG. 9B illustrates a processor core 990 including a front end unit 930 coupled to an execution engine unit 950, both of which may be coupled to a memory unit 970. The core 990 may be a reduced instruction set computing (RISC) core, a complex instruction set computing (CISC) core, a very long instruction word (VLIW) core, or a core of a hybrid or alternative core type, in different embodiments. In various embodiments, core 990 may be a special-purpose core, such as, for example, a network core, a communication core, a compression engine, a coprocessor core, a general-purpose computing graphics processing unit (GPGPU) core, a graphics core, or another type of special-purpose core.

In this example, front end unit 930 includes a branch prediction unit 932 coupled to an instruction cache unit 934. Instruction cache unit 934 may be coupled to an instruction translation lookaside buffer (TLB) 936. TLB 936 may be coupled to an instruction fetch unit 938, which may be coupled to a decode unit 940. Decode unit 940 may decode instructions, and may generate as an output one or more micro-operations, micro-code entry points, microinstructions, other instructions, or other control signals, which are decoded from, or which otherwise reflect, or are derived from, the original undecoded instructions. Decode unit 940 may be implemented using any of a variety of suitable mechanisms, in different embodiments. Examples of suitable mechanisms may include, but are not limited to, look-up tables, hardware circuitry, programmable logic arrays (PLAs), microcode read only memories (ROMs). In one embodiment, instruction cache unit 934 may be further coupled to a level 2 (L2) cache unit 976 in memory unit 970. In one embodiment, the core 990 may include a microcode ROM or other medium that stores microcode for certain macroinstructions (e.g., within decode unit 940 or elsewhere within the front end unit 930). The decode unit 940 may be coupled to a rename/allocator unit 952 within the execution engine unit 950.

In this example, execution engine unit 950 includes the rename/allocator unit 952, which may be coupled to a retirement unit 954 and a set of one or more scheduler unit(s) 956. Scheduler unit(s) 956 may represent any number of different schedulers of various types, including those that implement reservations stations or those that implement a central instruction window. As illustrated in this example, scheduler unit(s) 956 may be coupled to physical register file unit(s) 958. Each of the physical register file units 958 may represent one or more physical register files, different ones of which store data of one or more different data types including, but not limited to, scalar integer, scalar floating point, packed integer, packed floating point, vector integer, vector floating point, or status data types. One example of the use of a status data type may be an instruction pointer that indicates the address of the next instruction to be executed. In one embodiment, a physical register file unit 958 may include a vector register unit, a write mask register unit, and a scalar register unit (not shown). These register units may provide architectural vector registers, write mask registers (e.g., vector mask registers), and general-purpose registers.

In FIG. 9B, the physical register file unit(s) 958 are shown as being overlapped by the retirement unit 954 to illustrate various ways in which register renaming and out-of-order execution may be implemented. For example, in different embodiments, register renaming and out-of-order execution may be implemented using one or more reorder buffers and one or more retirement register files; using one or more future files, one or more history buffers, and one or more retirement register files; or using register maps and a pool of registers. In general, the architectural registers may be visible from the outside of the processor and/or from a programmer's perspective. The registers are not limited to any particular known type of circuit. Rather, any of a variety of different types of registers may be suitable for inclusion in core 990 as long as they store and provide data as described herein. Examples of suitable registers include, but are not limited to, dedicated physical registers, dynamically allocated physical registers using register renaming, and combinations of dedicated and dynamically allocated physical registers. In the example illustrated in FIG. 9B, retirement unit 954 and physical register file unit(s) 958 are coupled to the execution cluster(s) 960. Each of execution clusters 960 may include a set of one or more execution units 962 and a set of one or more memory access units 964. Execution units 962 may perform various operations (e.g., shifts, addition, subtraction, multiplication) and may operate on various types of data (e.g., scalar floating point, packed integer, packed floating point, vector integer, vector floating point). While some embodiments may include a number of execution units dedicated to specific functions or sets of functions, other embodiments may include only one execution unit, or may include multiple execution units all of which perform all supported functions or operations. In the example illustrated in FIG. 9B, scheduler unit(s) 956, physical register file unit(s) 958, and execution cluster(s) 960 are shown as potentially including a plurality of such units since some embodiments include separate pipelines for certain types of data/operations. For example, some embodiments may include a scalar integer pipeline, a scalar floating point/packed integer/packed floating point/vector integer/vector floating point pipeline, and/or a memory access pipeline, each of which includes its own scheduler unit, physical register file unit, and/or execution cluster. In some embodiments that include a separate memory access pipeline, only the execution cluster of this pipeline includes a memory access unit 964. It should also be understood that where separate pipelines are used, one or more of these pipelines may be out-of-order issue/execution pipelines and the rest may be in-order execution pipelines.

In the example illustrated in FIG. 9B, the set of memory access units 964 may be coupled to the memory unit 970, which includes a data TLB unit 972. Data TLB unit 972 may be coupled to a data cache unit 974, which in turn may be coupled to a level 2 (L2) cache unit 976. In one example embodiment, the memory access units 964 may include a load unit, a store address unit, and a store data unit, each of which may be coupled to the data TLB unit 972 in the memory unit 970. The L2 cache unit 976 may be coupled to one or more other levels of cache and, eventually, to a main memory. While FIG. 9B illustrates an embodiment in which instruction cache unit 934, data cache unit 974, and level 2 (L2) cache unit 976 reside within core 990, in other embodiments one or more caches or cache units may be internal to a core, external to a core, or apportioned internal to and external to a core in different combinations.

In one example embodiment, the register renaming, out-of-order issue/execution core architecture illustrated in FIG. 9B may implement pipeline 900 illustrated in FIG. 9B as follows. The instruction fetch unit 938 may perform the functions of the fetch and length decoding stages 902 and 904. The decode unit 940 may perform the functions of decode stage 906. The rename/allocator unit 952 may perform the functions of the allocation stage 908 and the renaming stage 910. The scheduler unit(s) 956 may perform the functions of the scheduling stage 912. The physical register file unit(s) 958 and the memory unit 970 may, collectively, perform the functions of the register read/memory read stage 914. The execution cluster(s) 960 may perform the functions of the execution stage 916. The memory unit 970 and the physical register file unit(s) 958 may, collectively, perform the functions of the write back/memory write stage 918. In different embodiments, various units (some of which may not be shown) may be involved in performing the functions of the exception handling stage 922. The retirement unit 954 and the physical register file unit(s) 958 may, collectively, perform the functions of the commit stage 924. In different embodiments, core 990 may support one or more instructions sets, including the instruction(s) described herein. For example, in various embodiments, core 990 may support the x86 instruction set (with or without extensions that have been included in recent versions); the MIPS instruction set of MIPS Technologies of Sunnyvale, Calif.; and/or the ARM instruction set of ARM Holdings of Sunnyvale, Calif. (with or without optional additional extensions such as NEON. In one embodiment, core 990 may include logic to support a packed data instruction set extension (e.g., AVX1 or AVX2), thereby allowing the operations used by many multimedia applications to be performed using packed data.

In some embodiments, core 990 may support multithreading (e.g., executing two or more parallel sets of operations or threads), and may do so in a variety of ways. Core 990 may, for example, include support for time sliced multithreading, simultaneous multithreading (in which a single physical core provides a logical core for each of the threads that the physical core is simultaneously executing), or a combination of time sliced and simultaneous multithreading. In one embodiment, for example, core 990 may include support for time sliced fetching and decoding, and for simultaneous multithreading in subsequent pipeline stages, such as in the Intel® Hyperthreading technology.

While register renaming is described herein in the context of out-of-order execution, it should be understood that register renaming may be used in an in-order architecture, in some embodiments. While in the example embodiment illustrated in FIG. 9B, core 990 includes separate instruction and data cache units 934 and 974, respectively, and a shared L2 cache unit 976, in other embodiments core 990 may include a single internal cache for both instructions and data, such as, for example, a Level 1 (L1) internal cache, or multiple levels of internal cache. In some embodiments, the system may include a combination of an internal cache and an external cache (e.g., a cache that is external to the core and/or the processor). In other embodiments, all of the caches may be external to the core and/or the processor.

### Specific Example In-Order Core Architecture

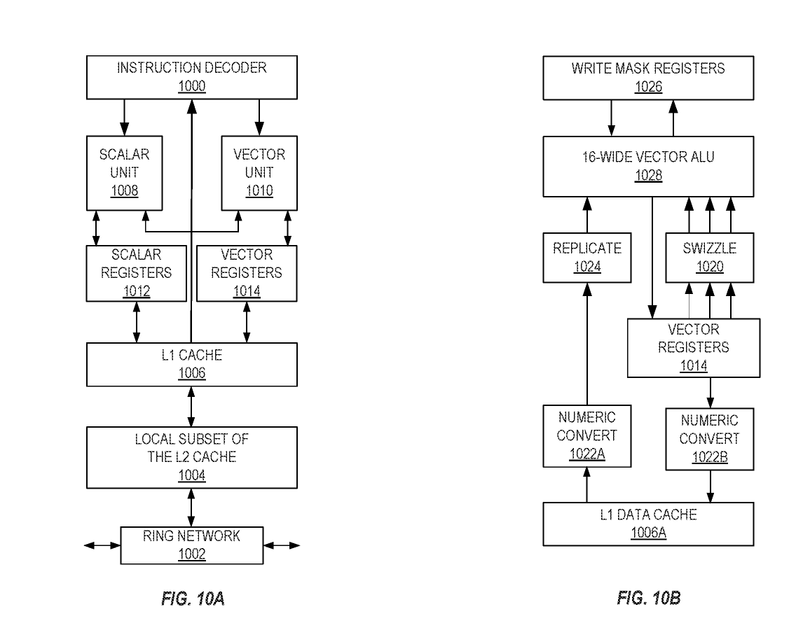

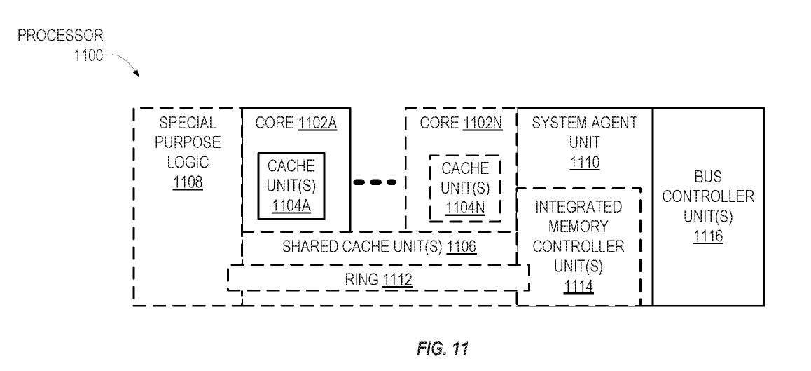

FIGS. 10A and 10B are block diagrams illustrating a more specific example of an in-order core architecture in which a core may be one of several logic blocks (including, for example, other cores of the same type and/or of different types) in a chip. As illustrated in this example, the logic blocks may communicate through a high-bandwidth, on-die interconnect network (e.g., a ring network) with some fixed function logic, memory I/O interfaces, and other necessary I/O logic, depending on the application.

FIG. 10A is a block diagram illustrating a single processor core, along with its connections to an on-die interconnect network (shown as ring network 1002) and to its local subset of a Level 2 (L2) cache 1004, according to some embodiments. In one embodiment, an instruction decoder 1000 may support the x86 instruction set with a packed data instruction set extension. An L1 cache 1006 may allow low-latency accesses to cache memory by the scalar and vector units. In one embodiment (e.g., to simplify the design), a scalar unit 1008 and a vector unit 1010 may use separate register sets (e.g., scalar registers 1012 and vector registers 1014, respectively) and data that is transferred between them may be written to memory and then read back in from level 1 (L1) cache 1006. However, other embodiments may use a different approach. For example, they may include a single register set or may include a communication path that allows data to be transferred between the two register files without being written to memory and read back.

In this example, the local subset of the L2 cache 1004 may be part of a global L2 cache that is divided into separate local subsets, e.g., with one subset per processor core. Each processor core may have a direct access path to its own local subset of the L2 cache 1004. Data read by a processor core may be stored in its L2 cache subset 1004 from which it can be accessed quickly and in parallel with accesses by other processor cores to their own local L2 cache subsets. Data written by a processor core and stored in its own L2 cache subset 1004 may be flushed from other L2 cache subsets, if necessary. In some embodiments, the ring network 1002 may ensure coherency for shared data. The ring network may be bi-directional to allow agents such as processor cores, L2 caches and other logic blocks to communicate with each other within the chip. In one embodiment, each ring datapath may be 1012 bits wide per direction.

FIG. 10B illustrates an expanded view of part of the processor core illustrated in FIG. 10A, according to some embodiments. In this example, FIG. 10B includes an L1 data cache 1006A, which may be part of the L1 cache 1004, as well as more detail regarding the vector unit 1010 and the vector registers 1014. Specifically, the vector unit 1010 may be a 16-wide vector processing unit (VPU) that includes a 16-wide vector ALU 1028. ALU 1028 may be configured to execute one or more of integer, single-precision float, and double-precision float instructions. The VPU may also support swizzling the register inputs (using swizzle unit 1020), numeric conversion (using numeric convert units 1022A and 1022B), and replication (using replication unit 1024) on the memory input. The inclusion of write mask registers 1026 may allow for predicating resulting vector writes.

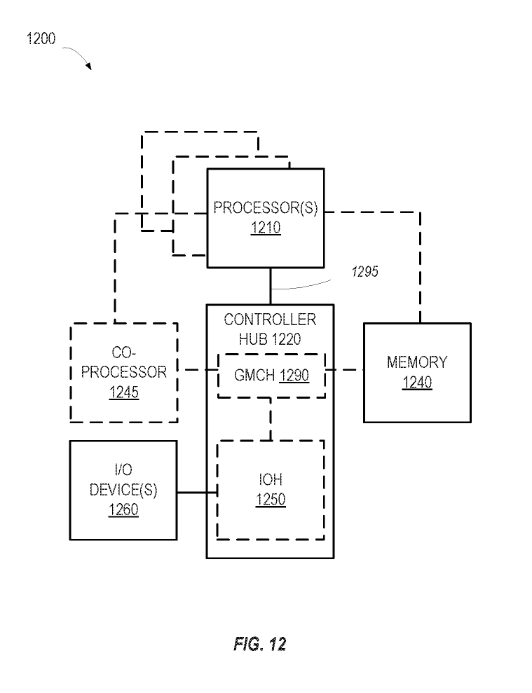

FIG. 11 is a block diagram illustrating a processor 1100 that may, in some embodiments, include more than one core, an integrated memory controller, and/or may special purpose logic (such as for integrated graphics computing). The solid lined boxes in FIG. 11 illustrate a processor 1100 that includes a single core 1102A, a system agent 1110, and a set of one or more bus controller units 1116. With the optional addition of the dashed lined boxes, an alternative embodiment of processor 1100 includes multiple cores 1102A-1102N, and also includes a set of one or more integrated memory controller unit(s) 1114 within the system agent unit 1110, and special purpose logic 1108. In some embodiments, one or more of cores 1102A-1102N may be similar to processor core 990 illustrated in FIG. 9B or the processor core illustrated in FIGS. 10A and 10B.

In some embodiments, processor 1100 may represent a CPU in which the special purpose logic 1108 includes integrated graphics and/or scientific logic (which may include one or more cores), and in which the cores 1102A-1102N include one or more general purpose cores (e.g., general purpose in-order cores, general purpose out-of-order cores, or a combination of the two). In other embodiments, processor 1100 may represent a coprocessor in which the cores 1102A-1102N include a large number of special purpose cores intended primarily for graphics and/or scientific computing (e.g., high throughput computing). In still other embodiments, processor 1100 may represent a coprocessor in which the cores 1102A-1102N include a large number of general purpose in-order cores. Thus, in different embodiments, the processor 1100 may be a general purpose processor, a coprocessor, or a special purpose processor, such as, for example, a network or communication processor, compression engine, graphics processor, GPGPU (general purpose graphics processing unit), a high-throughput “many integrated core” (MIC) coprocessor (including, for example, 30 or more cores), an embedded processor, or another type of processor. The processor 1100 may be implemented on one chip or on more than one chip, in different embodiments. The processor 1100 may be a part of and/or may be implemented on one or more substrates using any of a number of process technologies, such as, for example, BiCMOS, CMOS, or NMOS.

In the example illustrated in FIG. 11, the memory hierarchy includes one or more levels of cache within each of the cores 1102A-1102N, shown as cache units 1104A-1104N, a set of one or more shared cache units 1106, and external memory (not shown), some or all of which are coupled to the set of integrated memory controller units 1114. The set of shared cache units 1106 may include one or more mid-level caches, such as level 2 (L2) cache, a level 3 (L3) cache, a level 4 (L4) cache, other levels of cache, a last level cache (LLC), and/or combinations thereof. In one embodiment, a ring based interconnect unit 1112 may be used to interconnect the special purpose logic 1108 (which may include integrated graphics logic), the set of shared cache units 1106, and the system agent unit 1110/integrated memory controller unit(s) 1114. In other embodiments, any number of other suitable techniques may be used for interconnecting such units. In one embodiment, coherency may be maintained between one or more cache units 1106 and cores 1102A-1102N.

In some embodiments, one or more of the cores 1102A-1102N may be capable of multithreading. In some embodiments, the system agent 1110 may include circuitry or logic for coordinating and operating cores 1102A-1102N. For example, the system agent unit 1110 may include a power control unit (PCU) and a display unit. The PCU may be or include logic and circuitry for regulating the power state of the cores 1102A-1102N and the special purpose logic 1108 (which may include integrated graphics logic). The display unit may include circuitry or logic for driving one or more externally connected displays.

In various embodiments, the cores 1102A-1102N may be homogenous or heterogeneous in terms of architecture instruction set. That is, two or more of the cores 1102A-1102N may be capable of executing the same instruction set, while others may be capable of executing only a subset of that instruction set or may execute a different instruction set.

### Example Computer Architectures

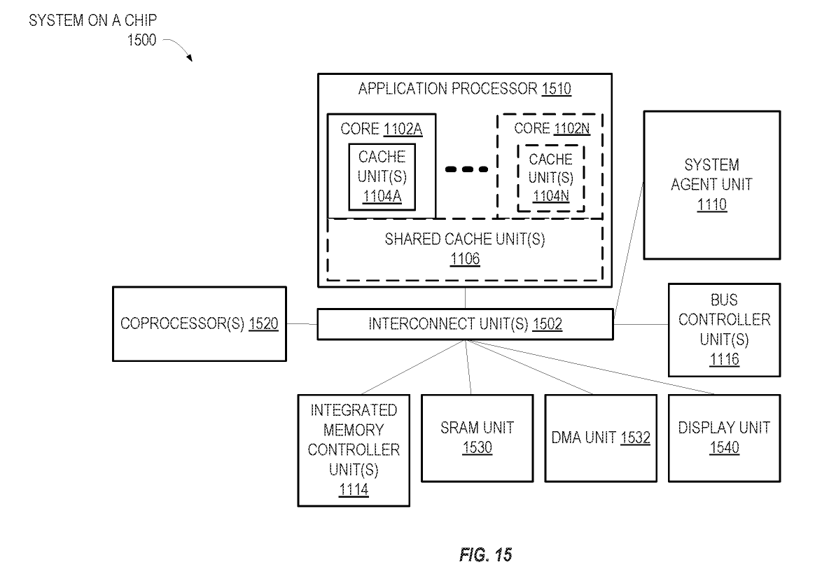

FIGS. 12 through 14 are block diagrams illustrating example systems suitable for the inclusion of one or more processors including, but not limited to, the processors described herein. FIG. 15 illustrates an example system on a chip (SoC) that may include one or more processor cores including, but not limited to, the processor cores described herein. Other system designs and configurations for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, may also be suitable for inclusion of the processors and/or processor cores described herein. In general, a huge variety of systems or electronic devices capable of incorporating a processor and/or other execution logic as disclosed herein are generally suitable for inclusion of the processors and/or processor cores described herein.

FIG. 12 is a block diagram illustrating a system 1200, in accordance with one embodiment of the present disclosure. As illustrated in this example, system 1200 may include one or more processors 1210, which are coupled to a controller hub 1220. In some embodiments, controller hub 1220 may include a graphics memory controller hub (GMCH) 1290 and an Input/Output Hub (IOH) 1250. In some embodiments, GMCH 1290 and IOH 1250 may be on separate chips. In this example, GMCH 1290 may include memory and graphics controllers (not shown) to which are coupled memory 1240 and a coprocessor 1245, respectively. In this example, IOH 1250 couples one or more input/output (I/O) devices 1260 to GMCH 1290. In various embodiments, one or both of the memory and graphics controllers may be integrated within the processor (as described herein), the memory 1240 and/or the coprocessor 1245 may be coupled directly to the processor(s) 1210, or the controller hub 1220 may be implemented in a single chip that includes the IOH 1250.

The optional nature of additional processors 1210 is denoted in FIG. 12 with broken lines. Each processor 1210 may include one or more of the processing cores described herein and may be implemented by a version of the processor 1100 illustrated in FIG. 11 and described herein.

In various embodiments, the memory 1240 may, for example, be dynamic random access memory (DRAM), phase change memory (PCM), or a combination of the two. In at least some embodiments, the controller hub 1220 may communicate with the processor(s) 1210 via a multi-drop bus such as a frontside bus (FSB), a point-to-point interface such as QuickPath Interconnect (QPI), or a similar connection, any one of which may be represented in FIG. 12 as interface 1295.

In one embodiment, the coprocessor 1245 may be a special purpose processor, such as, for example, a high-throughput MIC processor, a network or communication processor, a compression engine, a graphics processor, a GPGPU, an embedded processor, or another type of coprocessor. In one embodiment, controller hub 1220 may include an integrated graphics accelerator (not shown).

In some embodiments, there may be a variety of differences between the physical resources of different ones of the processors 1210. For example, there may be differences between the physical resources of the processors in terms of a spectrum of metrics of merit including architectural characteristics, micro-architectural characteristics, thermal characteristics, power consumption characteristics, and/or other performance-related characteristics.

In one embodiment, a processor 1210 may execute instructions that control data processing operations of a general type. Embedded within the instructions may be coprocessor instructions. The processor 1210 may recognize these coprocessor instructions as being of a type that should be executed by the attached coprocessor 1245. Accordingly, the processor 1210 may issue these coprocessor instructions (or control signals representing coprocessor instructions), on a coprocessor bus or other interconnect, to coprocessor 1245. Coprocessor(s) 1245 may accept and execute the received coprocessor instructions.

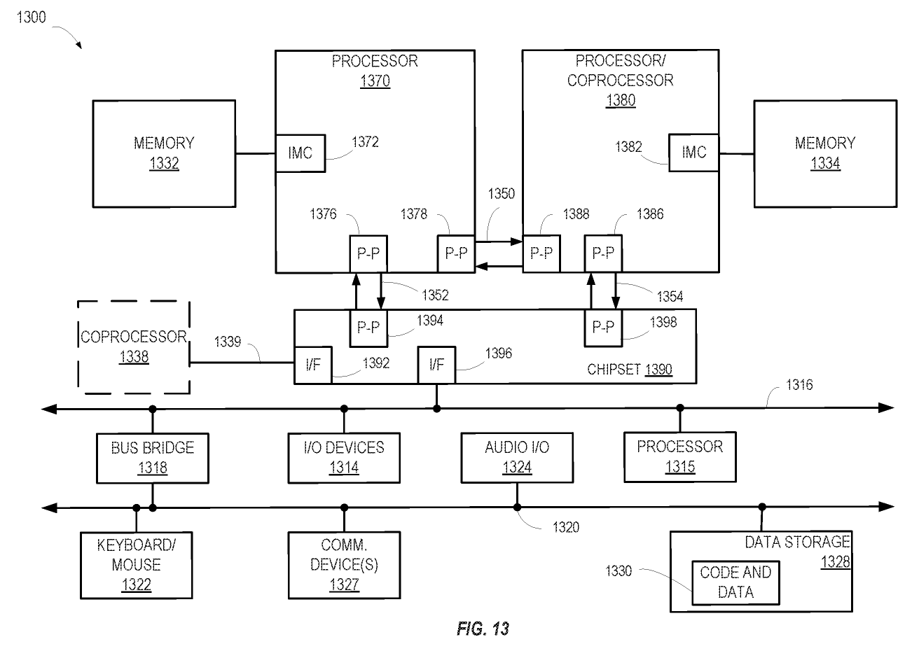

FIG. 13 is a block diagram illustrating a first example system 1300, in accordance with one embodiment of the present disclosure. As shown in FIG. 13, multiprocessor system 1300 implements a point-to-point interconnect system. For example, system 1300 includes a first processor 1370 and a second processor 1380 coupled to each other via a point-to-point interconnect 1350. In some embodiments, each of processors 1370 and 1380 may be a version of the processor 1100 illustrated in FIG. 11. In one embodiment, processors 1370 and 1380 may be implemented by respective processors 1210, while coprocessor 1338 may be implemented by a coprocessor 1245. In another embodiment, processors 1370 and 1380 may be implemented by a processor 1210 and a coprocessor 1245, respectively.

Processors 1370 and 1380 are shown including integrated memory controller (IMC) units 1372 and 1382, respectively. Processor 1370 also includes, as part of its bus controller units, point-to-point (P-P) interfaces 1376 and 1378. Similarly, processor 1380 includes P-P interfaces 1386 and 1388. Processors 1370 and 1380 may exchange information via a point-to-point (P-P) interface 1350 using P-P interface circuits 1378 and 1388. As shown in FIG. 13, IMCs 1372 and 1382 couple the processors to respective memories, shown as memory 1332 and memory 1334, which may be portions of a main memory that are locally attached to the respective processors.

Processors 1370 and 1380 may each exchange information with a chipset 1390 via individual P-P interfaces 1352 and 1354 respectively, using point to point interface circuits 1376, 1394, 1386, and 1398. Chipset 1390 may optionally exchange information with the coprocessor 1338 via interface 1392 over a high-performance interface 1339. In one embodiment, the coprocessor 1338 may be a special purpose processor, such as, for example, a high-throughput MIC processor, a network or communication processor, a compression engine, a graphics processor, a GPGPU, an embedded processor, or another type of special purpose processor. In one embodiment, coprocessor 1338 may include a high-performance graphics circuit and interface 1339 may be a high-performance graphics bus.

A shared cache (not shown) may be included in either processor or outside of both processors, yet may be connected with the processors via a P-P interconnect, such that either or both processors' local cache information may be stored in the shared cache if a processor is placed into a low power mode.

Chipset 1390 may be coupled to a first bus 1316 via an interface 1396. In various embodiments, first bus 1316 may be a Peripheral Component Interconnect (PCI) bus, a PCI Express bus, or another third generation I/O interconnect bus, although the scope of the present disclosure is not limited to these specific bus types.

As shown in FIG. 13, various I/O devices 1314 may be coupled to first bus 1316, along with a bus bridge 1318. Bus bridge 1318 may couple first bus 1316 to a second bus 1320. In one embodiment, one or more additional processor(s) 1315, such as one or more coprocessors, high-throughput MIC processors, GPGPU's, accelerators (e.g., graphics accelerators or digital signal processing (DSP) units), field programmable gate arrays, and/or any other processors, may be coupled to first bus 1316. In one embodiment, second bus 1320 may be a low pin count (LPC) bus. Various devices may be coupled to second bus 1320 including, for example, a keyboard and/or mouse 1322, one or more communication devices 1327 and a data storage unit 1328. Data storage unit 1328 may be a disk drive or another mass storage device, which may include instructions/code and data 1330, in one embodiment. In some embodiments, an audio I/O device 1324 may be coupled to the second bus 1320. Note that other architectures are possible. For example, instead of the point-to-point architecture illustrated in FIG. 13, a system may implement a multi-drop bus or another type of interconnect architecture.

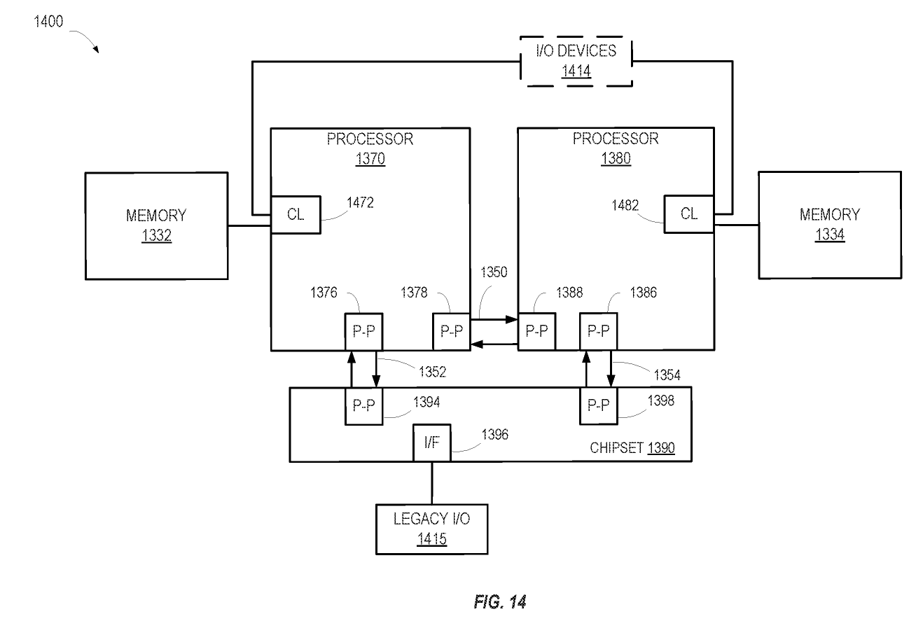

FIG. 14 is a block diagram illustrating a second example system 1400, in accordance with one embodiment of the present disclosure. Like elements in FIGS. 13 and 14 bear like reference numerals, and certain aspects of FIG. 13 have been omitted from FIG. 14 in order to avoid obscuring other aspects of FIG. 14.

FIG. 14 illustrates that the processors 1370 and 1380 may include integrated memory and I/O control logic (“CL”) units 1472 and 1482, respectively. Thus, CL 1472 and CL 1482 may include integrated memory controller units and may also include I/O control logic. FIG. 14 illustrates that not only are the memories 1332 and 1334 coupled to CL 1472 and CL 1482, respectively, but I/O devices 1414 are also coupled to CL 1472 and CL 1482. In this example system, legacy I/O devices 1415 may also be coupled to the chipset 1390 via an interface 1396.

FIG. 15 is a block diagram illustrating a system on a chip (SoC) 1500, in accordance with one embodiment of the present disclosure. Similar elements in FIGS. 15 and 11 bear like reference numerals. Also, dashed lined boxes represent optional features on more advanced SoCs. In FIG. 15, one or more interconnect unit(s) 1502 are coupled to an application processor 1510, which includes a set of one or more cores 1102A-1102N, including respective local cache units 1104A-1104N, and shared cache unit(s) 1106. The interconnect unit(s) 1502 are also coupled to a system agent unit 1110, one or more bus controller unit(s) 1116, one or more integrated memory controller unit(s) 1114, a set of one or more coprocessors 1520, a static random access memory (SRAM) unit 1530, a direct memory access (DMA) unit 1532, and a display unit 1540 for coupling to one or more external displays. In one embodiment, the coprocessor(s) 1520 may include a special purpose processor, such as, for example, a network or communication processor, a compression engine, a GPGPU, a high-throughput MIC processor, an embedded processor, or another type of coprocessor. In another embodiment, the coprocessor(s) 1520 may be a media processor that includes integrated graphics logic, an image processor, an audio processor, and/or a video processor.

In various embodiments, the mechanisms disclosed herein may be implemented in hardware, software, firmware, or a combination of such implementation approaches. Some embodiments of the disclosure may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and to generate output information. The output information may be applied to one or more output devices, in known fashion. For purposes of this disclosure, a processing system may include any system that includes a processor, such as, for example, a digital signal processor (DSP), a microcontroller, an application specific integrated circuit (ASIC), or a microprocessor.

In some embodiments, the program code may be implemented in a high level procedural or object oriented programming language to communicate with a processing system. The program code may also be implemented in assembly or machine language, in other embodiments. In fact, the mechanisms described herein are not limited in scope to any particular programming language. In general, the programming language may be a compiled language or an interpreted language.

One or more aspects of at least one embodiment may be implemented by representative instructions stored on a non-transitory, machine-readable medium which represents various logic within the processor, which when read by a machine causes the machine to fabricate logic to perform the techniques described herein. Such representations, sometimes referred to as “IP cores”, may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable memories (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure may also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off the processor.

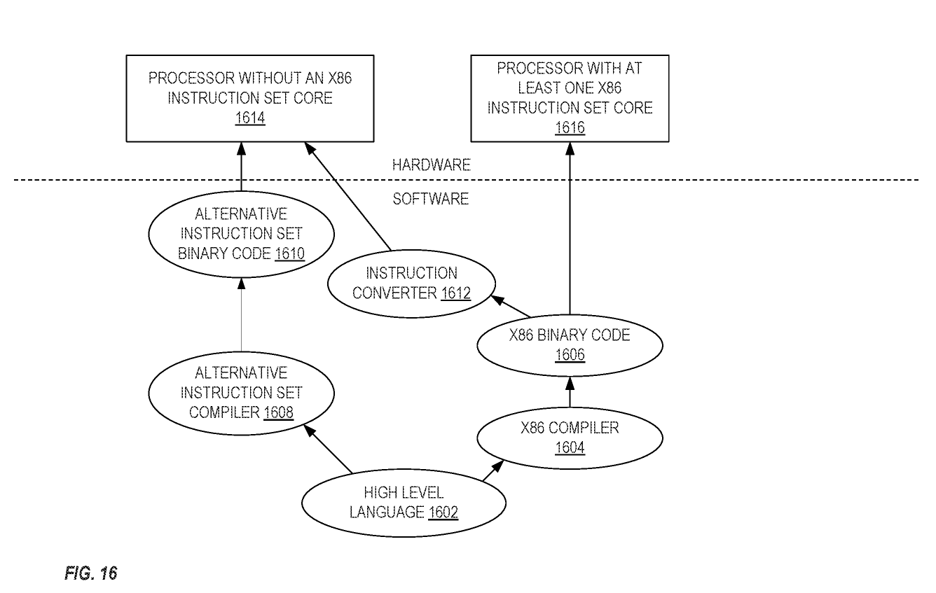

FIG. 16 is a block diagram illustrating the use of a compiler and a software instruction converter to convert binary instructions in a source instruction set to binary instructions in a target instruction set, according to some embodiments. In the illustrated embodiment, the instruction converter may be a software instruction converter, although in other embodiments the instruction converter may be implemented in software, firmware, hardware, or various combinations thereof. FIG. 16 illustrates that a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that may perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that may be operable to generate x86 binary code 1606 (e.g., object code) that may, with or without additional linkage processing, be executed on the processor with at least one x86 instruction set core 1616. Similarly, FIG. 16 illustrates that the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). Instruction converter 1612 may be used to convert x86 binary code 1606 into code that may be natively executed by the processor without an x86 instruction set core 1614. This converted code might not be the same as the alternative instruction set binary code 1610; however, the converted code will accomplish the general operation and be made up of instructions from the alternative instruction set. Thus, instruction converter 1612 represents software, firmware, hardware, or a combination thereof that, through emulation, simulation or any other process, allows a processor or other electronic device that does not have an x86 instruction set processor or core to execute x86 binary code 1606.

Thus, techniques for performing one or more instructions according to at least one embodiment are disclosed. While certain example embodiments have been described and shown in the accompanying drawings, it is to be understood that such embodiments are merely illustrative of and not restrictive on other embodiments, and that such embodiments not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

Some embodiments of the present disclosure include a processor. In at least some of these embodiments, the processor may include a decoder, a branch resolution code generator, one or more execution units, and a branch predictor. The decoder may be to decode a first instance of a branch instruction that occurs multiple times in an input instruction stream and for which a resolved branch direction for each instance of the branch instruction is data dependent, the branch instruction being associated with an address identifier, and to add results of decoding the first instance of the branch instruction to a stream of decoded instructions to be executed by the processor. The branch resolution code generator may be to inject, into the stream of decoded instructions to be executed, branch resolution code executable to resolve, for a second instance of the branch instruction in the input instruction stream, a branch condition on which the resolved branch direction for each instance of the branch instruction in the input instruction stream is dependent, the second instance of the branch instruction following the first instance of the branch instruction in the input instruction stream at a predetermined look-ahead distance. The one or more execution units may be to execute the branch resolution code, and to store an indication of the resolved branch direction for the second instance of the branch instruction in an entry of a prediction queue associated with the address identifier. The branch predictor may be to receive the second instance of the branch instruction, and to output, as a predicted branch direction for the second instance of the branch instruction, the resolved branch direction for the second instance of the branch instruction stored in the entry of the prediction queue associated with the address identifier. In combination with any of the above embodiments, the branch predictor may further include a baseline branch predictor to generate, based at least in part on a branch history, an initial prediction of a branch direction for the second instance of the branch instruction, and the branch predictor may further be to determine that the entry of the prediction queue associated with the address identifier stores a resolved branch direction for the second instance of the branch instruction, and to override, responsive to the determination that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction. In combination with any of the above embodiments, the entry of the prediction queue associated with the address identifier may store a plurality of resolved branch directions for respective instances of the branch instruction, and the resolved branch direction for the second instance of the branch instruction may be stored in the entry of the prediction queue associated with the address identifier at a location identified by a prediction pointer for the branch instruction with which the first instance of the branch instruction is annotated. In combination with any of the above embodiments, the plurality of resolved branch directions may be stored in the entry as a vector of branch direction predictions, each of which is associated with a respective indicator of its validity. In combination with any of the above embodiments, the predetermined look-ahead distance may be dependent on a distance between the prediction pointer for the branch instruction with which the first instance of the branch instruction is annotated and a branch pointer for the branch instruction with which the first instance of the branch instruction is annotated, and the branch pointer may identify a location in the entry of the prediction queue associated with the address identifier at which a resolved branch direction for the first instance of the branch instruction is stored. In combination with any of the above embodiments, to inject the branch resolution code into the stream of decoded instructions, the branch resolution code generator may further be to modify the branch resolution code to enforce the predetermined look-ahead distance. In combination with any of the above embodiments, the branch resolution code generator may further be to inject, into the stream of decoded instructions to be executed, branch resolution code executable to resolve, for a third instance of the branch instruction in the input instruction stream, a branch condition on which the resolved branch direction for each instance of the branch instruction in the input instruction stream is dependent, the third instance of the branch instruction following the second instance of the branch instruction in the input instruction stream at another predetermined look-ahead distance. The other predetermined look-ahead distance may be different than the predetermined distance, and the other predetermined look-ahead distance may be dependent on a distance between the prediction pointer for the branch instruction with which the second instance of the branch instruction is annotated and a branch pointer for the branch instruction with which the second instance of the branch instruction is annotated. In combination with any of the above embodiments, the processor may further include a history queue storing data representing retired instructions, and the branch resolution code generator may further be to generate the branch resolution code. To generate the branch resolution code, the branch resolution code generator may further be to traverse the history queue backward from a third instance of the branch instruction that is retired to identify one or more instructions on whose execution the branch condition is dependent, and one or more registers to which the one or more identified instructions write values on which the branch condition is dependent, to add, to the branch resolution code alternate instructions executable to write values on which the branch condition is dependent to temporary registers, and an instruction to write the indication of the resolved branch direction for the second instance of the branch instruction to the entry of the prediction queue associated with the address identifier. In combination with any of the above embodiments, the processor may further be to validate the branch resolution code. To validate the branch resolution code, the processor may further be to confirm that the one or more identified instructions on whose execution the branch condition is dependent and the one or more registers to which the one or more identified instructions write values on which the branch condition is dependent are consistent for a plurality of instances of the branch instruction in the history queue, and to enable injection of the branch resolution code into the stream of decoded instructions, responsive to a successful validation of the branch resolution code. In combination with any of the above embodiments, the processor may further be to attempt to validate the branch resolution code. To attempt to validate the branch resolution code, the processor may further be to determine whether or not the one or more identified instructions on whose execution the branch condition is dependent and the one or more registers to which the one or more identified instructions write values on which the branch condition is dependent are consistent for a plurality of instances of the branch instruction in the history queue, and to refrain from injecting the branch resolution code into the stream of decoded instructions, responsive to an unsuccessful attempt to validate the branch resolution code. In any of the above embodiments, execution of the branch resolution code may produce no side effects. In combination with any of the above embodiments, the branch resolution code generator may further be to determine, prior to decoding the first instance of the branch instruction, that the branch instruction occurs multiple times in the input instruction stream and that a resolved branch direction for each instance of the branch instruction is data dependent, the determination based on one or more of a count of the number of instances of the branch instruction that have retired, a count of the number of times the branch direction was mispredicted for an instance of the branch instruction, and a percentage of instances of the branch instruction for which the branch direction was mispredicted.

Some embodiments of the present disclosure include a method. In at least some of these embodiments, the method may include, in a processor, decoding a first instance of a branch instruction for which a resolved branch direction is data dependent, the branch instruction being associated with an address identifier, adding results of decoding the first instance of the branch instruction to a stream of decoded instructions to be executed in the processor, injecting, into the stream of decoded instructions, branch resolution code for resolving, for a second instance of the branch instruction, a branch condition on which resolved branch directions for instances of the branch instruction are dependent, the second instance following the first instance in an input instruction stream at a predetermined look-ahead distance, executing the branch resolution code, including storing an indication of the resolved branch direction for the second instance of the branch instruction in an entry of a prediction queue associated with the address identifier, receiving the second instance of the branch instruction, and outputting, as a predicted branch direction for the second instance of the branch instruction, the resolved branch direction stored in the entry of the prediction queue. In combination with any of the above embodiments, method may further include generating, based at least in part on a branch history, an initial prediction of a branch direction for the second instance of the branch instruction, determining that the entry of the prediction queue associated with the address identifier stores a resolved branch direction for the second instance of the branch instruction, and overriding, in response to determining that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction. In combination with any of the above embodiments, the entry of the prediction queue associated with the address identifier may store a plurality of resolved branch directions for respective instances of the branch instruction, and the resolved branch direction for the second instance of the branch instruction may be stored in the entry of the prediction queue associated with the address identifier at a location identified by a prediction pointer for the branch instruction with which the first instance of the branch instruction is annotated. In any of the above embodiments, the plurality of resolved branch directions may be stored in the entry as a vector of branch direction predictions, each of which is associated with a respective indicator of its validity. In combination with any of the above embodiments, the predetermined look-ahead distance may be dependent on a distance between the prediction pointer for the branch instruction with which the first instance of the branch instruction is annotated and a branch pointer for the branch instruction with which the first instance of the branch instruction is annotated, and the branch pointer may identify a location in the entry of the prediction queue associated with the address identifier at which a resolved branch direction for the first instance of the branch instruction is stored. In combination with any of the above embodiments, injecting the branch resolution code into the stream of decoded instructions may include modifying the branch resolution code to enforce the predetermined look-ahead distance. In combination with any of the above embodiments, the method may further include injecting, into the stream of decoded instructions to be executed, branch resolution code executable to resolve, for a third instance of the branch instruction in the input instruction stream, a branch condition on which the resolved branch direction for each instance of the branch instruction in the input instruction stream is dependent, the third instance of the branch instruction following the second instance of the branch instruction in the input instruction stream at another predetermined look-ahead distance. The other predetermined look-ahead distance may be different than the predetermined distance, and the other predetermined look-ahead distance may be dependent on a distance between the prediction pointer for the branch instruction with which the second instance of the branch instruction is annotated and a branch pointer for the branch instruction with which the second instance of the branch instruction is annotated. In combination with any of the above embodiments, the method may further include generating the branch resolution code, including traversing a history queue storing data representing retired instructions backward from a third instance of the branch instruction that is retired to identify one or more instructions on whose execution the branch condition is dependent, and one or more registers to which the one or more identified instructions write values on which the branch condition is dependent, and adding, to the branch resolution code alternate instructions executable to write values on which the branch condition is dependent to temporary registers, an instruction to write the indication of the resolved branch direction for the second instance of the branch instruction to the entry of the prediction queue associated with the address identifier. In combination with any of the above embodiments, the method may further include validating the branch resolution code, including confirming that the one or more identified instructions on whose execution the branch condition is dependent and the one or more registers to which the one or more identified instructions write values on which the branch condition is dependent are consistent for a plurality of instances of the branch instruction in the history queue, and enabling injection of the branch resolution code into the stream of decoded instructions, in response to successfully validating the branch resolution code. In combination with any of the above embodiments, the method may further include determining whether or not the one or more identified instructions on whose execution the branch condition is dependent and the one or more registers to which the one or more identified instructions write values on which the branch condition is dependent are consistent for a plurality of instances of the branch instruction in the history queue, and refraining from injecting the branch resolution code into the stream of decoded instructions, in response to an unsuccessful attempt to validate the branch resolution code. In any of the above embodiments, executing the branch resolution code may produce no side effects. In combination with any of the above embodiments, the method may further include determining, prior to decoding the first instance of the branch instruction, that the branch instruction occurs multiple times in the input instruction stream and that a resolved branch direction for each instance of the branch instruction is data dependent, the determining being based on one or more of a count of the number of instances of the branch instruction that have retired, a count of the number of times the branch direction was mispredicted for an instance of the branch instruction, and a percentage of instances of the branch instruction for which the branch direction was mispredicted.

Some embodiments of the present disclosure include a system. In at least some of these embodiments, the system may include a decoder, a branch resolution code generator, one or more execution units, and a branch predictor. The decoder may be to decode a first instance of a branch instruction that occurs multiple times in an input instruction stream and for which a resolved branch direction for each instance of the branch instruction is data dependent, the branch instruction being associated with an address identifier, and to add results of decoding the first instance of the branch instruction to a stream of decoded instructions to be executed in the system. The branch resolution code generator may be to inject, into the stream of decoded instructions to be executed, branch resolution code executable to resolve, for a second instance of the branch instruction in the input instruction stream, a branch condition on which the resolved branch direction for each instance of the branch instruction in the input instruction stream is dependent, the second instance of the branch instruction following the first instance of the branch instruction in the input instruction stream at a predetermined look-ahead distance. The one or more execution units may be to execute the branch resolution code, and to store an indication of the resolved branch direction for the second instance of the branch instruction in an entry of a prediction queue associated with the address identifier. The branch predictor may be to receive the second instance of the branch instruction, and to output, as a predicted branch direction for the second instance of the branch instruction, the resolved branch direction for the second instance of the branch instruction stored in the entry of the prediction queue associated with the address identifier. In combination with any of the above embodiments, the branch predictor may further include a baseline branch predictor to generate, based at least in part on a branch history, an initial prediction of a branch direction for the second instance of the branch instruction, and the branch predictor may further be to determine that the entry of the prediction queue associated with the address identifier stores a resolved branch direction for the second instance of the branch instruction, and to override, responsive to the determination that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction. In combination with any of the above embodiments, the entry of the prediction queue associated with the address identifier may store a plurality of resolved branch directions for respective instances of the branch instruction, and the resolved branch direction for the second instance of the branch instruction may be stored in the entry of the prediction queue associated with the address identifier at a location identified by a prediction pointer for the branch instruction with which the first instance of the branch instruction is annotated. In combination with any of the above embodiments, the plurality of resolved branch directions may be stored in the entry as a vector of branch direction predictions, each of which is associated with a respective indicator of its validity. In combination with any of the above embodiments, the predetermined look-ahead distance may be dependent on a distance between the prediction pointer for the branch instruction with which the first instance of the branch instruction is annotated and a branch pointer for the branch instruction with which the first instance of the branch instruction is annotated, and the branch pointer may identify a location in the entry of the prediction queue associated with the address identifier at which a resolved branch direction for the first instance of the branch instruction is stored. In combination with any of the above embodiments, to inject the branch resolution code into the stream of decoded instructions, the branch resolution code generator may further be to modify the branch resolution code to enforce the predetermined look-ahead distance. In combination with any of the above embodiments, the branch resolution code generator may further be to inject, into the stream of decoded instructions to be executed, branch resolution code executable to resolve, for a third instance of the branch instruction in the input instruction stream, a branch condition on which the resolved branch direction for each instance of the branch instruction in the input instruction stream is dependent, the third instance of the branch instruction following the second instance of the branch instruction in the input instruction stream at another predetermined look-ahead distance. The other predetermined look-ahead distance may be different than the predetermined distance, and the other predetermined look-ahead distance may be dependent on a distance between the prediction pointer for the branch instruction with which the second instance of the branch instruction is annotated and a branch pointer for the branch instruction with which the second instance of the branch instruction is annotated. In combination with any of the above embodiments, the system may further include a history queue storing data representing retired instructions. The branch resolution code generator may further be to generate the branch resolution code. To generate the branch resolution code, the branch resolution code generator may further be to traverse the history queue backward from a third instance of the branch instruction that is retired to identify one or more instructions on whose execution the branch condition is dependent, and one or more registers to which the one or more identified instructions write values on which the branch condition is dependent, and to add, to the branch resolution code, alternate instructions executable to write values on which the branch condition is dependent to temporary registers, an instruction to write the indication of the resolved branch direction for the second instance of the branch instruction to the entry of the prediction queue associated with the address identifier. In combination with any of the above embodiments, the system may further be to validate the branch resolution code. To validate the branch resolution code, the system may further be to confirm that the one or more identified instructions on whose execution the branch condition is dependent and the one or more registers to which the one or more identified instructions write values on which the branch condition is dependent are consistent for a plurality of instances of the branch instruction in the history queue, and to enable injection of the branch resolution code into the stream of decoded instructions, responsive to a successful validation of the branch resolution code. In combination with any of the above embodiments, the system may further be to attempt to validate the branch resolution code. To attempt to validate the branch resolution code, the system may further be to determine whether or not the one or more identified instructions on whose execution the branch condition is dependent and the one or more registers to which the one or more identified instructions write values on which the branch condition is dependent are consistent for a plurality of instances of the branch instruction in the history queue, and to refrain from injecting the branch resolution code into the stream of decoded instructions, responsive to an unsuccessful attempt to validate the branch resolution code. In any of the above embodiments, execution of the branch resolution code may produce no side effects. In combination with any of the above embodiments, the branch resolution code generator may further be to determine, prior to decoding the first instance of the branch instruction, that the branch instruction occurs multiple times in the input instruction stream and that a resolved branch direction for each instance of the branch instruction is data dependent, the determination based on one or more of a count of the number of instances of the branch instruction that have retired, a count of the number of times the branch direction was mispredicted for an instance of the branch instruction, and a percentage of instances of the branch instruction for which the branch direction was mispredicted.

Some embodiments of the present disclosure include a system. In at least some of these embodiments, the system may include means for decoding a first instance of a branch instruction for which a resolved branch direction is data dependent, the branch instruction being associated with an address identifier, means for adding results of decoding the first instance of the branch instruction to a stream of decoded instructions to be executed in the processor, means for injecting, into the stream of decoded instructions, branch resolution code for resolving, for a second instance of the branch instruction, a branch condition on which resolved branch directions for instances of the branch instruction are dependent, the second instance following the first instance in an input instruction stream at a predetermined look-ahead distance, means for executing the branch resolution code, including storing an indication of the resolved branch direction for the second instance of the branch instruction in an entry of a prediction queue associated with the address identifier, means for receiving the second instance of the branch instruction, and means for outputting, as a predicted branch direction for the second instance of the branch instruction, the resolved branch direction stored in the entry of the prediction queue. In combination with any of the above embodiments, the apparatus may further include means for generating, based at least in part on a branch history, an initial prediction of a branch direction for the second instance of the branch instruction, means for determining that the entry of the prediction queue associated with the address identifier stores a resolved branch direction for the second instance of the branch instruction, and means for overriding, in response to determining that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction. In combination with any of the above embodiments, the entry of the prediction queue associated with the address identifier may store a plurality of resolved branch directions for respective instances of the branch instruction, and the resolved branch direction for the second instance of the branch instruction may be stored in the entry of the prediction queue associated with the address identifier at a location identified by a prediction pointer for the branch instruction with which the first instance of the branch instruction is annotated. In combination with any of the above embodiments, the plurality of resolved branch directions may be stored in the entry as a vector of branch direction predictions, each of which is associated with a respective indicator of its validity. In combination with any of the above embodiments, the predetermined look-ahead distance may be dependent on a distance between the prediction pointer for the branch instruction with which the first instance of the branch instruction is annotated and a branch pointer for the branch instruction with which the first instance of the branch instruction is annotated, and the branch pointer may identify a location in the entry of the prediction queue associated with the address identifier at which a resolved branch direction for the first instance of the branch instruction is stored. In combination with any of the above embodiments, the means for injecting the branch resolution code into the stream of decoded instructions may include means for modifying the branch resolution code to enforce the predetermined look-ahead distance. In combination with any of the above embodiments, the apparatus may further include means for injecting, into the stream of decoded instructions to be executed, branch resolution code executable to resolve, for a third instance of the branch instruction in the input instruction stream, a branch condition on which the resolved branch direction for each instance of the branch instruction in the input instruction stream is dependent, the third instance of the branch instruction following the second instance of the branch instruction in the input instruction stream at another predetermined look-ahead distance. The other predetermined look-ahead distance may be different than the predetermined distance, and the other predetermined look-ahead distance may be dependent on a distance between the prediction pointer for the branch instruction with which the second instance of the branch instruction is annotated and a branch pointer for the branch instruction with which the second instance of the branch instruction is annotated. In combination with any of the above embodiments, the apparatus may further include means for generating the branch resolution code, including means for traversing a history queue storing data representing retired instructions backward from a third instance of the branch instruction that is retired to identify one or more instructions on whose execution the branch condition is dependent, and one or more registers to which the one or more identified instructions write values on which the branch condition is dependent, and means for adding, to the branch resolution code, alternate instructions executable to write values on which the branch condition is dependent to temporary registers, an instruction to write the indication of the resolved branch direction for the second instance of the branch instruction to the entry of the prediction queue associated with the address identifier. In combination with any of the above embodiments, the apparatus may further include means for validating the branch resolution code, including means for confirming that the one or more identified instructions on whose execution the branch condition is dependent and the one or more registers to which the one or more identified instructions write values on which the branch condition is dependent are consistent for a plurality of instances of the branch instruction in the history queue, and means for enabling injection of the branch resolution code into the stream of decoded instructions, in response to successfully validating the branch resolution code. In combination with any of the above embodiments, the apparatus may further include means for determining whether or not the one or more identified instructions on whose execution the branch condition is dependent and the one or more registers to which the one or more identified instructions write values on which the branch condition is dependent are consistent for a plurality of instances of the branch instruction in the history queue, and means for refraining from injecting the branch resolution code into the stream of decoded instructions, in response to an unsuccessful attempt to validate the branch resolution code. In any of the above embodiments, executing the branch resolution code may produce no side effects. In combination with any of the above embodiments, the apparatus may further include means for determining, prior to decoding the first instance of the branch instruction, that the branch instruction occurs multiple times in the input instruction stream and that a resolved branch direction for each instance of the branch instruction is data dependent, the determining being based on one or more of a count of the number of instances of the branch instruction that have retired, a count of the number of times the branch direction was mispredicted for an instance of the branch instruction, and a percentage of instances of the branch instruction for which the branch direction was mispredicted.

Some embodiments of the present disclosure include at least one non-transitory machine readable storage medium, comprising computer-executable instructions carried on the machine readable medium, the instructions readable by a processor. In at least some of these embodiments, the instructions, when read and executed, may be for causing the processor to decode a first instance of a branch instruction for which a resolved branch direction is data dependent, the branch instruction being associated with an address identifier, to add results of decoding the first instance of the branch instruction to a stream of decoded instructions to be executed in the processor, to inject, into the stream of decoded instructions, branch resolution code for resolving, for a second instance of the branch instruction, a branch condition on which resolved branch directions for instances of the branch instruction are dependent, the second instance following the first instance in an input instruction stream at a predetermined look-ahead distance, to execute the branch resolution code, to store an indication of the resolved branch direction for the second instance of the branch instruction in an entry of a prediction queue associated with the address identifier, to receive the second instance of the branch instruction, and to output, as a predicted branch direction for the second instance of the branch instruction, the resolved branch direction stored in the entry of the prediction queue. In combination with any of the above embodiments, the instructions may further be for causing the processor to generate, based at least in part on a branch history, an initial prediction of a branch direction for the second instance of the branch instruction, to determine that the entry of the prediction queue associated with the address identifier stores a resolved branch direction for the second instance of the branch instruction, and to override, in response to determining that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction. In combination with any of the above embodiments, the entry of the prediction queue associated with the address identifier may store a plurality of resolved branch directions for respective instances of the branch instruction, and the resolved branch direction for the second instance of the branch instruction may be stored in the entry of the prediction queue associated with the address identifier at a location identified by a prediction pointer for the branch instruction with which the first instance of the branch instruction is annotated. In combination with any of the above embodiments, the plurality of resolved branch directions may be stored in the entry as a vector of branch direction predictions, each of which is associated with a respective indicator of its validity. In combination with any of the above embodiments, the predetermined look-ahead distance may be dependent on a distance between the prediction pointer for the branch instruction with which the first instance of the branch instruction is annotated and a branch pointer for the branch instruction with which the first instance of the branch instruction is annotated, and the branch pointer may identify a location in the entry of the prediction queue associated with the address identifier at which a resolved branch direction for the first instance of the branch instruction is stored. In combination with any of the above embodiments, to inject the branch resolution code into the stream of decoded instructions, the instructions may further be for causing the processor to modify the branch resolution code to enforce the predetermined look-ahead distance. In combination with any of the above embodiments, the instructions may further be for causing the processor to inject, into the stream of decoded instructions to be executed, branch resolution code executable to resolve, for a third instance of the branch instruction in the input instruction stream, a branch condition on which the resolved branch direction for each instance of the branch instruction in the input instruction stream is dependent, the third instance of the branch instruction following the second instance of the branch instruction in the input instruction stream at another predetermined look-ahead distance. The other predetermined look-ahead distance may be different than the predetermined distance, and the other predetermined look-ahead distance may be dependent on a distance between the prediction pointer for the branch instruction with which the second instance of the branch instruction is annotated and a branch pointer for the branch instruction with which the second instance of the branch instruction is annotated. In combination with any of the above embodiments, the instructions may further be for causing the processor to generate the branch resolution code. To generate the branch resolution code, the instructions may further be for causing the processor to traverse a history queue storing data representing retired instructions backward from a third instance of the branch instruction that is retired to identify one or more instructions on whose execution the branch condition is dependent, and one or more registers to which the one or more identified instructions write values on which the branch condition is dependent, and to add to the branch resolution code alternate instructions executable to write values on which the branch condition is dependent to temporary registers, and an instruction to write the indication of the resolved branch direction for the second instance of the branch instruction to the entry of the prediction queue associated with the address identifier. In combination with any of the above embodiments, the instructions may further be for causing the processor to validate the branch resolution code, to validate the branch resolution code, the instructions may further be for causing the processor to confirm that the one or more identified instructions on whose execution the branch condition is dependent and the one or more registers to which the one or more identified instructions write values on which the branch condition is dependent are consistent for a plurality of instances of the branch instruction in the history queue, and to enable injection of the branch resolution code into the stream of decoded instructions, in response to successfully validating the branch resolution code. In combination with any of the above embodiments, the instructions may further be for causing the processor to determine whether or not the one or more identified instructions on whose execution the branch condition is dependent and the one or more registers to which the one or more identified instructions write values on which the branch condition is dependent are consistent for a plurality of instances of the branch instruction in the history queue, and to refrain from injecting the branch resolution code into the stream of decoded instructions, in response to an unsuccessful attempt to validate the branch resolution code. In combination with any of the above embodiments, executing the branch resolution code may not produce any side effects. In combination with any of the above embodiments, the instructions may further be for causing the processor to determine, prior to decoding the first instance of the branch instruction, that the branch instruction occurs multiple times in the input instruction stream and that a resolved branch direction for each instance of the branch instruction is data dependent, the determining being based on one or more of a count of the number of instances of the branch instruction that have retired, a count of the number of times the branch direction was mispredicted for an instance of the branch instruction, and a percentage of instances of the branch instruction for which the branch direction was mispredicted.

What is claimed is:

1. A processor, comprising:
a decoder;
a branch resolution code generator;
one or more execution units; and
a branch predictor;
wherein:
the decoder is to:
decode a first instance of a branch instruction that occurs multiple times in an input instruction stream and for which a resolved branch direction for each instance of the branch instruction is data dependent, the branch instruction being associated with an address identifier;
add results of decoding the first instance of the branch instruction to a stream of decoded instructions to be executed by the processor;
the branch resolution code generator is to:
inject, into the stream of decoded instructions to be executed, branch resolution code executable to resolve, for a second instance of the branch instruction in the input instruction stream, a branch condition on which the resolved branch direction for each instance of the branch instruction in the input instruction stream is dependent, the second instance of the branch instruction following the first instance of the branch instruction in the input instruction stream at a predetermined look-ahead distance;
the one or more execution units are to:
execute the branch resolution code;
store an indication of the resolved branch direction for the second instance of the branch instruction in an entry of a prediction queue associated with the address identifier;
the branch predictor is to:
receive the second instance of the branch instruction;
output, as a predicted branch direction for the second instance of the branch instruction, the resolved branch direction for the second instance of the branch instruction stored in the entry of the prediction queue associated with the address identifier.

2. The processor of claim 1, wherein:
the branch predictor comprises:
a baseline branch predictor to generate, based at least in part on a branch history, an initial prediction of a branch direction for the second instance of the branch instruction;
the branch predictor is further to:
determine that the entry of the prediction queue associated with the address identifier stores a resolved branch direction for the second instance of the branch instruction;
override, responsive to the determination that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction.

3. The processor of claim 1, wherein:
the entry of the prediction queue associated with the address identifier stores a plurality of resolved branch directions for respective instances of the branch instruction;
the resolved branch direction for the second instance of the branch instruction is stored in the entry of the prediction queue associated with the address identifier at a location identified by a prediction pointer for the branch instruction with which the first instance of the branch instruction is annotated.

4. The processor of claim 3, wherein:
the predetermined look-ahead distance is dependent on a distance between the prediction pointer for the branch instruction with which the first instance of the branch instruction is annotated and a branch pointer for the branch instruction with which the first instance of the branch instruction is annotated;
the branch pointer identifies a location in the entry of the prediction queue associated with the address identifier at which a resolved branch direction for the first instance of the branch instruction is stored.

5. The processor of claim 4, wherein to inject the branch resolution code into the stream of decoded instructions, the branch resolution code generator is further to:
modify the branch resolution code to enforce the predetermined look-ahead distance.

6. The processor of claim 1, wherein:
the processor further comprises a history queue storing data representing retired instructions;
the branch resolution code generator is further to generate the branch resolution code;
to generate the branch resolution code, the branch resolution code generator is further to:
traverse the history queue backward from a third instance of the branch instruction that is retired to identify:
one or more instructions on whose execution the branch condition is dependent; and
one or more registers to which the one or more identified instructions write values on which the branch condition is dependent;
add, to the branch resolution code:
alternate instructions executable to write values on which the branch condition is dependent to temporary registers;
an instruction to write the indication of the resolved branch direction for the second instance of the branch instruction to the entry of the prediction queue associated with the address identifier.

7. The processor of claim 6, wherein:
the processor is further to validate the branch resolution code;
to validate the branch resolution code, the processor is further:
confirm that the one or more identified instructions on whose execution the branch condition is dependent and the one or more registers to which the one or more identified instructions write values on which the branch condition is dependent are consistent for a plurality of instances of the branch instruction in the history queue;
enable injection of the branch resolution code into the stream of decoded instructions, responsive to a successful validation of the branch resolution code.

8. A method comprising, in a processor:
decoding a first instance of a branch instruction for which a resolved branch direction is data dependent, the branch instruction being associated with an address identifier;
adding results of decoding the first instance of the branch instruction to a stream of decoded instructions to be executed in the processor;
injecting, into the stream of decoded instructions, branch resolution code for resolving, for a second instance of the branch instruction, a branch condition on which resolved branch directions for instances of the branch instruction are dependent, the second instance following the first instance in an input instruction stream at a predetermined look-ahead distance;
executing the branch resolution code, including storing an indication of the resolved branch direction for the second instance of the branch instruction in an entry of a prediction queue associated with the address identifier;
receiving the second instance of the branch instruction; and
outputting, as a predicted branch direction for the second instance of the branch instruction, the resolved branch direction stored in the entry of the prediction queue.

9. The method of claim 8, further comprising:
generating, based at least in part on a branch history, an initial prediction of a branch direction for the second instance of the branch instruction;
determining that the entry of the prediction queue associated with the address identifier stores a resolved branch direction for the second instance of the branch instruction;
overriding, in response to determining that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction.

10. The method of claim 8, wherein:
the entry of the prediction queue associated with the address identifier stores a plurality of resolved branch directions for respective instances of the branch instruction;
the resolved branch direction for the second instance of the branch instruction is stored in the entry of the prediction queue associated with the address identifier at a location identified by a prediction pointer for the branch instruction with which the first instance of the branch instruction is annotated.

11. The method of claim 10, wherein:
the predetermined look-ahead distance is dependent on a distance between the prediction pointer for the branch instruction with which the first instance of the branch instruction is annotated and a branch pointer for the branch instruction with which the first instance of the branch instruction is annotated;
the branch pointer identifies a location in the entry of the prediction queue associated with the address identifier at which a resolved branch direction for the first instance of the branch instruction is stored.

12. The method of claim 8, further comprising:
generating the branch resolution code, including:
traversing a history queue storing data representing retired instructions backward from a third instance of the branch instruction that is retired to identify:
one or more instructions on whose execution the branch condition is dependent; and
one or more registers to which the one or more identified instructions write values on which the branch condition is dependent;
adding, to the branch resolution code:
alternate instructions executable to write values on which the branch condition is dependent to temporary registers;
an instruction to write the indication of the resolved branch direction for the second instance of the branch instruction to the entry of the prediction queue associated with the address identifier.

13. The method of claim 12, further comprising:
validating the branch resolution code, including:
confirming that the one or more identified instructions on whose execution the branch condition is dependent and the one or more registers to which the one or more identified instructions write values on which the branch condition is dependent are consistent for a plurality of instances of the branch instruction in the history queue;
enabling injection of the branch resolution code into the stream of decoded instructions, in response to successfully validating the branch resolution code.

14. A system, comprising:
a decoder;
a branch resolution code generator;
one or more execution units; and
a branch predictor;
wherein:
the decoder is to:
decode a first instance of a branch instruction that occurs multiple times in an input instruction stream and for which a resolved branch direction for each instance of the branch instruction is data dependent, the branch instruction being associated with an address identifier;
add results of decoding the first instance of the branch instruction to a stream of decoded instructions to be executed in the system;
the branch resolution code generator is to:
inject, into the stream of decoded instructions to be executed, branch resolution code executable to resolve, for a second instance of the branch instruction in the input instruction stream, a branch condition on which the resolved branch direction for each instance of the branch instruction in the input instruction stream is dependent, the second instance of the branch instruction following the first instance of the branch instruction in the input instruction stream at a predetermined look-ahead distance;
the one or more execution units are to:
execute the branch resolution code;
store an indication of the resolved branch direction for the second instance of the branch instruction in an entry of a prediction queue associated with the address identifier;
the branch predictor is to:
receive the second instance of the branch instruction;
output, as a predicted branch direction for the second instance of the branch instruction, the resolved branch direction for the second instance of the branch instruction stored in the entry of the prediction queue associated with the address identifier.

15. The system of claim 14, wherein;
the branch predictor comprises:
a baseline branch predictor to generate, based at least in part on a branch history, an initial prediction of a branch direction for the second instance of the branch instruction;
the branch predictor is further to:
determine that the entry of the prediction queue associated with the address identifier stores a resolved branch direction for the second instance of the branch instruction;
override, responsive to the determination that the entry of the prediction queue associated with the address identifier stores a resolved branch direction for the second instance of the branch instruction, the initial prediction of a branch direction for the second instance of the branch instruction in favor of the resolved branch direction for the second instance of the branch instruction.

16. The system of claim 14, wherein:
the entry of the prediction queue associated with the address identifier stores a plurality of resolved branch directions for respective instances of the branch instruction;
the resolved branch direction for the second instance of the branch instruction is stored in the entry of the prediction queue associated with the address identifier at a location identified by a prediction pointer for the branch instruction with which the first instance of the branch instruction is annotated.

17. The system of claim 16, wherein:
the predetermined look-ahead distance is dependent on a distance between the prediction pointer for the branch instruction with which the first instance of the branch instruction is annotated and a branch pointer for the branch instruction with which the first instance of the branch instruction is annotated;
the branch pointer identifies a location in the entry of the prediction queue associated with the address identifier at which a resolved branch direction for the first instance of the branch instruction is stored.

18. The system of claim 17, wherein to inject the branch resolution code into the stream of decoded instructions, the branch resolution code generator is further to:
modify the branch resolution code to enforce the predetermined look-ahead distance.

19. The system of claim 14, wherein:
the system further comprises a history queue storing data representing retired instructions;
the branch resolution code generator is further to generate the branch resolution code;
to generate the branch resolution code, the branch resolution code generator is to:
traverse the history queue backward from a third instance of the branch instruction that is retired to identify:
one or more instructions on whose execution the branch condition is dependent; and
one or more registers to which the one or more identified instructions write values on which the branch condition is dependent;
add, to the branch resolution code:
alternate instructions executable to write values on which the branch condition is dependent to temporary registers;
an instruction to write the indication of the resolved branch direction for the second instance of the branch instruction to the entry of the prediction queue associated with the address identifier.

20. The system of claim 19, wherein:
the system is further to validate the branch resolution code;
to validate the branch resolution code, the system is further to:
confirm that the one or more identified instructions on whose execution the branch condition is dependent and the one or more registers to which the one or more identified instructions write values on which the branch condition is dependent are consistent for a plurality of instances of the branch instruction in the history queue;
the system is further to enable injection of the branch resolution code into the stream of decoded instructions, responsive to a successful validation of the branch resolution code.
